(19) United States
(12) Patent Application Publication
(10) Pub. No.: US 2026/0155940 A1
(43) Pub. Date: Jun. 4, 2026

(54) COMMUNICATION METHOD AND COMMUNICATION APPARATUS

(71) Applicant: HUAWEI TECHNOLOGIES CO., LTD., Shenzhen (CN)

(72) Inventors: Shuming Seng, Beijing (CN); Chenwan Li, Beijing (CN)

(21) Appl. No.: 19/459,018

(22) Filed: Jan. 26, 2026

Related U.S. Application Data
(63) Continuation of application No. PCT/CN2024/106508, filed on Jul. 19, 2024.

(30) Foreign Application Priority Data
Jul. 28, 2023 (CN) 202310944356.X

(51) Int. Cl. H04L 5/00; H04L 5/22

(52) U.S. Cl. CPC H04L 5/0053; H04L 5/0044; H04L 5/22

(57) ABSTRACT

A communication method and a communication apparatus. A first signal is received from a network device, where the first signal is useable for time synchronization, and the first signal is useable to indicate at least one time unit in a first time period. First data is sent to the network device in a first time unit, where the first time unit is one of the at least one time unit. A terminal device determines the first time unit based on the first signal, and sends the first data in the first time unit.

### CROSS-REFERENCE TO RELATED APPLICATIONS

This application is a continuation of International Application No. PCT/CN 2024/106508, filed on Jul. 19, 2024, which claims priority to Chinese Patent Application No. 202310944356.X, filed on Jul. 28, 2023. The disclosures of the aforementioned applications are hereby incorporated by reference in their entireties.

### BACKGROUND

A long range wide area network (long range wide area network, LoRaWAN) is a low power consumption wide area network, which can provide secure bidirectional communication for a terminal device with low costs and power consumption. The LoRaWAN has three operating modes: Class A (Class A), Class B (Class B), and Class C (Class C). The Class B operating mode is an operating mode in which power consumption and performance are balanced. A terminal device in the Class B operating mode periodically receives a beacon (beacon) signal, where the beacon signal is useable for time synchronization between the terminal device and a gateway.

An uplink transmission mechanism of the LoRaWAN is simple. The terminal device may initiate access at any moment except a receive window, and different terminal devices may initiate access at a same moment. Consequently, a transmission collision frequently occurs.

### SUMMARY

At least one embodiment provide a communication method and a communication apparatus, to reduce a probability that a transmission collision occurs in a LoRaWAN.

According to a first aspect, at least one embodiment provides a communication method. An execution body of the method may be a terminal device or an apparatus (for example, a chip) useable in the terminal device. The following uses an example in which the execution body is the terminal device for description. The method includes: receiving a first signal from a network device, where the first signal is useable for time synchronization, and the first signal is useable to indicate at least one time unit in a first time period; and sending first data to the network device in the first time unit, where the first time unit is one of the at least one time unit.

In a conventional LoRaWAN, the terminal device may initiate access at any moment except a receive window. After a transmission collision occurs, a moment at which the terminal device re-initiates access is not limited. Consequently, a transmission collision frequently occurs. In at least one embodiment, the terminal device determines the at least one time unit based on the first signal. Some or all of the at least one time unit are useable to initiate access or send data. The terminal device initiates access or sends data in some or all of the at least one time unit, for example, in the first time unit. Because a transmission moment is no longer any moment, this embodiment can reduce a probability of a transmission collision. In addition, the terminal device may further perform channel monitoring based on a time unit. In response to a current time unit being occupied, the terminal device is able to not continue performing channel monitoring in the current time unit. Therefore, this embodiment can also reduce monitoring power consumption of the terminal device.

Optionally, before the sending the first data to the network device in the first time unit, the method includes: determining that the first time unit is not occupied.

Before sending the first data, the terminal device may determine, in one or more manners, whether the first time unit is occupied. In response to the first time unit not being occupied, the terminal device may send the first data in the first time unit. In response to the first time unit having been occupied, the terminal device does not send the first data in the first time unit. Therefore, this embodiment can reduce a probability of a transmission collision.

Optionally, the determining that the first time unit is not occupied includes: determining, through channel monitoring, that the first time unit is not occupied.

The terminal device may initiate access at any moment in the first time unit. Therefore, the terminal device may monitor a channel before sending the first data. In response to the terminal device detecting that the channel has been occupied, the terminal device does not send the first data in the first time unit. In response to the terminal device detecting that the channel is not occupied, the terminal device may send the first data in the first time unit. Therefore, this embodiment can reduce a probability of a transmission collision.

Optionally, the first signal includes fourth indication information, the fourth indication information is useable to indicate that the first time unit is not occupied, and the determining that the first time unit is not occupied includes: determining, based on the fourth indication information, that the first time unit is not occupied.

In some cases, the first time unit may be useable for retransmission. The network device may indicate, based on indication information, whether the first time unit is occupied. For example, the network device is useable to indicate, based on the fourth indication information, that the first time unit is not occupied. In response to the terminal device not receiving the fourth indication information, the terminal device does not send the first data in the first time unit. In response to the terminal device receiving the fourth indication information, the terminal device may send the first data in the first time unit, or may determine, after performing channel monitoring, whether to send the first data in the first time unit. In this way, in response to the network device scheduling uplink transmission in the first time unit, the network device may indicate, based on the indication information, that the first time unit is occupied, to avoid a collision, and reduce monitoring power consumption of the terminal.

Optionally, the first signal includes first indication information, and the first indication information is useable to indicate that the first time unit is an uplink time unit.

In comparison with a solution in which the uplink time unit is determined based on a synchronization sequence, this embodiment does not pose an excessively high goal for a receiving capability of the terminal device and can reduce costs of the terminal device.

Optionally, the first signal includes second indication information, and the second indication information is useable to indicate a length of each of the at least one time unit.

In comparison with a solution in which a length of each time unit is preset, a length of each time unit in the first time period can be flexibly set in this embodiment.

Optionally, the first signal includes third indication information, and the third indication information is useable to indicate a quantity of the at least one time unit.

In comparison with a solution in which a quantity of time units is preset, a quantity of the time units in the first time period can be flexibly set in this embodiment.

Optionally, the at least one time unit in the first time period includes a plurality of time units, and the first time unit is any one of the plurality of time units.

In response to the first signal being useable to indicate the plurality of time units in the first time period, the terminal device may initiate access in any one of the plurality of time units, and no indication of the network device is used, so that signaling overheads can be reduced.

Optionally, the method further includes: receiving a synchronization signal from the network device in the first time period.

In some cases, for example, in response to the terminal device being high in power, the terminal device may receive the synchronization signal from the network device in the first time period, so that time synchronization between the terminal device and the network device is more accurate, and a probability that transmission fails is reduced.

Optionally, the method further includes: receiving a second signal from the network device, where the second signal is useable for time synchronization, the second signal is useable to indicate at least one time unit in a second time period, the at least one time unit in the second time period includes a second time unit useable for downlink transmission, and the second time unit has an association relationship with the first time unit; and receiving second data in the second time unit.

For example, the association relationship is that a location of the second time unit in the second time period is the same as a location of the first time unit in the first time period. Based on the association relationship, the terminal device may turn on a receive circuit in a part of the second time period (that is, the second time unit), and is able to not turn on the receive circuit in the entire second time period, so that power consumption of the terminal device can be reduced.

Optionally, the second data is feedback information of the first data, and the method further includes: in response to the feedback information not being received in the second time unit, or in response to the feedback information being useable to indicate that data transmission fails, retransmitting the first data in a third time unit in a third time period, where the third time period is after the second time period, and the third time unit is useable for uplink transmission.

After transmission of the first data fails, in response to the terminal device retransmitting the first data at any moment in the third time period, a transmission collision is likely to occur to a great extent. In at least one embodiment, the terminal device retransmits the first data at a specific moment (that is, the third time unit) in the third time period, to reduce a probability of a transmission collision.

Optionally, the method further includes: receiving fifth indication information from the network device in the second time unit, where the fifth indication information is useable to indicate the third time unit.

The network device specifies, based on the fifth indication information, a dedicated time unit (that is, the third time unit) for the terminal device to retransmit the first data, so that a transmission collision can be avoided in response to the terminal device retransmitting the first data, thereby avoiding a power waste caused by a plurality of retransmissions.

According to a second aspect, at least one embodiment provides a communication method. An execution body of the method may be a network device or a chip useable in the network device. The following uses an example in which the execution body is the network device for description. The method includes: sending a first signal to a terminal device, where the first signal is useable for time synchronization, and the first signal is useable to indicate at least one time unit in a first time period; and receiving first data from the terminal device in a first time unit in the at least one time unit.

In a conventional LoRaWAN, the terminal device may initiate access at any moment except a receive window. After a transmission collision occurs, a moment at which the terminal device re-initiates access is not limited. Consequently, a transmission collision frequently occurs. In at least one embodiment, the terminal device determines the at least one time unit based on the first signal. Some or all of the at least one time unit are useable to initiate access or send data. The terminal device initiates access or sends data in some or all of the at least one time unit, for example, in the first time unit. Because a transmission moment is no longer any moment, this embodiment can reduce a probability of a transmission collision. In addition, the terminal device may further perform channel monitoring based on a time unit. In response to a current time unit being occupied, the terminal device is able to not continue performing channel monitoring in the current time unit. Therefore, this embodiment can also reduce monitoring power consumption of the terminal device.

Optionally, the first signal includes first indication information, and the first indication information is useable to indicate that the first time unit is an uplink time unit.

In comparison with a solution in which the uplink time unit is determined based on a synchronization sequence, this embodiment does not pose an excessively high goal for a receiving capability of the terminal device and can reduce costs of the terminal device.

Optionally, the first signal includes second indication information, and the second indication information is useable to indicate a length of each of the at least one time unit.

In comparison with a solution in which a length of each time unit is preset, a length of each time unit in the first time period can be flexibly set in this embodiment.

Optionally, the first signal includes third indication information, and the third indication information is useable to indicate a quantity of the at least one time unit.

In comparison with a solution in which a quantity of time units is preset, a quantity of the time units in the first time period can be flexibly set in this embodiment.

Optionally, the first signal includes fourth indication information, and the fourth indication information is useable to indicate that the first time unit is not occupied.

In some cases, the first time unit may be useable for retransmission. The network device may indicate, based on indication information, whether the first time unit is occupied. For example, the network device is useable to indicate, based on the fourth indication information, that the first time unit is not occupied. In response to the terminal device not receiving the fourth indication information, the terminal device does not send the first data in the first time unit. In response to the terminal device receiving the fourth indication information, the terminal device may send the first data in the first time unit, or may determine, after performing channel monitoring, whether to send the first data in the first time unit. In this way, in response to the network device scheduling uplink transmission in the first time unit, the network device may indicate, based on the indication information, that the first time unit is occupied, to avoid a collision, and reduce monitoring power consumption of the terminal.

Optionally, the at least one time unit in the first time period includes a plurality of time units, and the first time unit is any one of the plurality of time units.

In response to the first signal is being useable to indicate the plurality of time units in the first time period, the terminal device may initiate access in any one of the plurality of time units, and no indication of the network device is relied upon, so that signaling overheads can be reduced.

Optionally, the method further includes: sending a synchronization signal to the terminal device in the first time period.

In some cases, for example, in response to the terminal device being high in power, the network device may send the synchronization signal to the terminal device in the first time period, so that time synchronization between the terminal device and the network device is more accurate, and a probability that transmission fails is reduced.

Optionally, the method further includes: sending a second signal to the terminal device, where the second signal is useable for time synchronization, the second signal is useable to indicate at least one time unit in a second time period, the at least one time unit in the second time period includes a second time unit useable for downlink communication, and the second time unit has an association relationship with the first time unit; and sending second data in the second time unit.

For example, the association relationship is that a location of the second time unit in the second time period is the same as a location of the first time unit in the first time period. Based on the association relationship, the terminal device may turn on a receive circuit in a part of the second time period (that is, the second time unit), and is able to not turn on the receive circuit in the entire second time period, so that power consumption of the terminal device can be reduced.

Optionally, the second data is feedback information of the first data. In response to the first data failing to be received, the method further includes: receiving the first data in a third time unit in a third time period, where the third time period is after the second time period, and the third time unit is useable for uplink transmission.

After transmission of the first data fails, in response to the terminal device retransmitting the first data at any moment in the third time period, a transmission collision is likely to occur to a great extent. In at least one embodiment, the terminal device retransmits the first data at a specific moment (that is, the third time unit) in the third time period, and the network device receives the first data at the specific moment (that is, the third time unit) in the third time period, to reduce a probability of a transmission collision.

Optionally, the method further includes: sending fifth indication information to the terminal device in the second time unit, where the fifth indication information is useable to indicate the third time unit.

The network device specifies, based on the fifth indication information, a dedicated time unit (that is, the third time unit) for the terminal device to retransmit the first data, so that a transmission collision can be avoided in response to the terminal device retransmitting the first data, thereby avoiding a power waste caused by a plurality of retransmissions.

According to a third aspect, at least one embodiment provides a communication method. An execution body of the method may be a terminal device or a chip useable in the terminal device. The following uses an example in which the execution body is the terminal device for description. The method includes: receiving a first signal from a network device, where the first signal is useable for time synchronization, and the first signal is useable to indicate at least one time unit in a first time period; and receiving third data from the network device in a first time unit, where the first time unit is one of the at least one time unit.

In a conventional LoRaWAN, a terminal device determines a large quantity of parameters, and determines a receive window based on a complex local mechanism (a pingslot state machine). In at least one embodiment, the network device is useable to indicate a downlink time unit based on the first signal, and the terminal device can determine the downlink time unit without using the complex local mechanism, so that computing overheads and power consumption of the terminal device are reduced.

Optionally, the first signal includes first indication information, and the first indication information is useable to indicate that the first time unit is the downlink time unit.

In comparison with a solution in which the downlink time unit is determined based on a synchronization sequence, this embodiment does not pose an excessively high goal for a receiving capability of the terminal device and can reduce costs of the terminal device.

Optionally, the first signal includes second indication information, and the second indication information is useable to indicate a length of each of the at least one time unit.

In comparison with a solution in which a length of each time unit is preset, a length of each time unit in the first time period can be flexibly set in this embodiment.

Optionally, the first signal includes third indication information, and the third indication information is useable to indicate a quantity of the at least one time unit.

In comparison with a solution in which a quantity of time units is preset, a length of each time unit in the first time period can be flexibly set in this embodiment.

According to a fourth aspect, at least one embodiment provides a communication method. An execution body of the method may be a network device or a chip useable in the network device. The following uses an example in which the execution body is the network device for description. The method includes: sending a first signal to a terminal device, where the first signal is useable for time synchronization, and the first signal is useable to indicate at least one time unit in a first time period; and sending third data to the terminal device in a first time unit, where the first time unit is one of the at least one time unit.

In a conventional LoRaWAN, a terminal device is used to determine a large quantity of parameters, and determine a receive window based on a complex local mechanism (a pingslot state machine). In at least one embodiment, the network device is useable to indicate a downlink time unit based on the first signal, and the terminal device can determine the downlink time unit without using the complex local mechanism, so that computing overheads and power consumption of the terminal device are reduced.

Optionally, the first signal includes first indication information, and the first indication information is useable to indicate that the first time unit is the downlink time unit.

In comparison with a solution in which the downlink time unit is determined based on a synchronization sequence, this embodiment does not pose an excessively high goal for a receiving capability of the terminal device and can reduce costs of the terminal device.

Optionally, the first signal includes second indication information, and the second indication information is useable to indicate a length of each of the at least one time unit.

In comparison with a solution in which a length of each time unit is preset, a length of each time unit in the first time period can be flexibly set in this embodiment.

Optionally, the first signal includes third indication information, and the third indication information is useable to indicate a quantity of the at least one time unit.

In comparison with a solution in which a quantity of time units is preset, a length of each time unit in the first time period can be flexibly set in this embodiment.

According to a fifth aspect, at least one embodiment provides a communication method. An execution body of the method may be a terminal device or a chip useable in the terminal device. The following uses an example in which the execution body is the terminal device for description. The method includes: receiving a first signal, where the first signal is useable for time synchronization, the first signal is useable to indicate at least one time unit in a first time period, the first signal includes first indication information, the first indication information is useable to indicate that a first time unit is useable for uplink transmission or downlink transmission, and the first time unit is one of the at least one time unit; and in response to the first time unit being useable for uplink transmission, sending first data to a network device in the first time unit; or in response to the first time unit being useable for downlink transmission, receiving third data from a network device in the first time unit.

In a conventional LoRaWAN, the terminal device may initiate access at any moment except a receive window. After a transmission collision occurs, a moment at which the terminal device re-initiates access is not limited. Consequently, a transmission collision frequently occurs. In at least one embodiment, the terminal device determines the at least one time unit based on the first signal. Some or all of the at least one time unit are useable to initiate access or send data. The terminal device initiates access or sends data in some or all of the at least one time unit, for example, in the first time unit. Because a transmission moment is no longer any moment, this embodiment can reduce a probability of a transmission collision. In addition, the terminal device may further perform channel monitoring based on a time unit. In response to a current time unit being occupied, the terminal device is able to not continue performing channel monitoring in the current time unit. Therefore, this embodiment can also reduce monitoring power consumption of the terminal device. In a conventional LoRaWAN, a terminal device determines a large quantity of parameters, and determines a receive window based on a complex local mechanism (a pingslot state machine). In at least one embodiment, the network device is useable to indicate a downlink time unit based on the first signal, and the terminal device can determine the downlink time unit without using the complex local mechanism, so that computing overheads and power consumption of the terminal device are reduced.

Optionally, before the sending the first data to the network device in the first time unit, the method includes: determining that the first time unit is not occupied.

Before sending the first data, the terminal device may determine, in one or more manners, whether the first time unit is occupied. In response to the first time unit not being occupied, the terminal device may send the first data in the first time unit. In response to the first time unit has been occupied, the terminal device does not send the first data in the first time unit. Therefore, this embodiment can reduce a probability of a transmission collision.

Optionally, the determining that the first time unit is not occupied includes: determining, through channel monitoring, that the first time unit is not occupied.

The terminal device may initiate access at any moment in the first time unit. Therefore, the terminal device may monitor a channel before sending the first data. In response to the terminal device detecting that the channel has been occupied, the terminal device does not send the first data in the first time unit. In response to the terminal device detecting that the channel is not occupied, the terminal device may send the first data in the first time unit. Therefore, this embodiment can reduce a probability of a transmission collision.

Optionally, the first signal includes fourth indication information, the fourth indication information is useable to indicate that the first time unit is not occupied, and the determining that the first time unit is not occupied includes: determining, based on the fourth indication information, that the first time unit is not occupied.

In some cases, the first time unit may be useable for retransmission. The network device may indicate, based on indication information, whether the first time unit is occupied. For example, the network device is useable to indicate, based on the fourth indication information, that the first time unit is not occupied. In response to the terminal device not receiving the fourth indication information, the terminal device does not send the first data in the first time unit. In response to the terminal device receiving the fourth indication information, the terminal device may send the first data in the first time unit, or may determine, after performing channel monitoring, whether to send the first data in the first time unit. In this way, in response to the network device scheduling uplink transmission in the first time unit, the network device may indicate, based on the indication information, that the first time unit is occupied, to avoid a collision, and reduce monitoring power consumption of the terminal.

Optionally, the first signal includes second indication information, and the second indication information is useable to indicate a length of each of the at least one time unit.

In comparison with a solution in which a length of each time unit is preset, a length of each time unit in the first time period can be flexibly set in this embodiment.

Optionally, the first signal includes third indication information, and the third indication information is useable to indicate a quantity of the at least one time unit.

In comparison with a solution in which a quantity of time units is preset, a quantity of the time units in the first time period can be flexibly set in this embodiment.

Optionally, in response to the first time unit being useable for uplink transmission, the at least one time unit in the first time period includes a plurality of time units, and the first time unit is any one of the plurality of time units.

In response to the first signal being useable to indicate the plurality of time units in the first time period, the terminal device may initiate access in any one of the plurality of time units, and no indication of the network device is relied upon, so that signaling overheads can be reduced.

Optionally, in response to the first time unit being useable for uplink transmission, the method further includes: receiving a synchronization signal from the network device in the first time period.

In some cases, for example, in response to the terminal device being high in power, the terminal device may receive the synchronization signal from the network device in the first time period, so that time synchronization between the terminal device and the network device is more accurate, and a probability that transmission fails is reduced.

Optionally, in response to the first time unit being useable for uplink transmission, the method further includes: receiving a second signal from the network device, where the second signal is useable for time synchronization, the second signal is useable to indicate at least one time unit in a second time period, the at least one time unit in the second time period includes a second time unit useable for downlink transmission, and the second time unit has an association relationship with the first time unit; and receiving second data in the second time unit.

For example, the association relationship is that a location of the second time unit in the second time period is the same as a location of the first time unit in the first time period. Based on the association relationship, the terminal device may turn on a receive circuit in a part of the second time period (that is, the second time unit), and is able to not turn on the receive circuit in the entire second time period, so that power consumption of the terminal device can be reduced.

Optionally, the second data is feedback information of the first data, and the method further includes: in response to the feedback information not being received in the second time unit, or in response to the feedback information being useable to indicate that data transmission fails, retransmitting the first data in a third time unit in a third time period, where the third time period is after the second time period, and the third time unit is useable for uplink transmission.

After transmission of the first data fails, in response to the terminal device retransmitting the first data at any moment in the third time period, a transmission collision is likely to occur to a great extent. In at least one embodiment, the terminal device retransmits the first data at a specific moment (that is, the third time unit) in the third time period, to reduce a probability of a transmission collision.

Optionally, the method further includes: receiving fifth indication information from the network device in the second time unit, where the fifth indication information is useable to indicate the third time unit.

The network device specifies, based on the fifth indication information, a dedicated time unit (that is, the third time unit) for the terminal device to retransmit the first data, so that a transmission collision can be avoided in response to the terminal device retransmitting the first data, thereby avoiding a power waste caused by a plurality of retransmissions.

According to a sixth aspect, at least one embodiment provides a communication method. An execution body of the method may be a network device or a chip useable in the network device. The following uses an example in which the execution body is the network device for description. The method includes: sending a first signal, where the first signal is useable for time synchronization, the first signal is useable to indicate at least one time unit in a first time period, the first signal includes first indication information, the first indication information is useable to indicate that the first time unit is useable for uplink transmission or downlink transmission, and the first time unit is one of the at least one time unit; and in response to the first time unit being useable for uplink transmission, receiving first data from a terminal device in the first time unit; or in response to the first time unit being useable for downlink transmission, sending third data to the terminal device in the first time unit.

In a conventional LoRaWAN, the terminal device may initiate access at any moment except a receive window. After a transmission collision occurs, a moment at which the terminal device re-initiates access is not limited. Consequently, a transmission collision frequently occurs. In at least one embodiment, the terminal device determines the at least one time unit based on the first signal. Some or all of the at least one time unit are useable to initiate access or send data. The terminal device initiates access or sends data in some or all of the at least one time unit, for example, in the first time unit. Because a transmission moment is no longer any moment, this embodiment can reduce a probability of a transmission collision. In addition, the terminal device may further perform channel monitoring based on a time unit. In response to a current time unit being occupied, the terminal device is able to not continue performing channel monitoring in the current time unit. Therefore, this embodiment can also reduce monitoring power consumption of the terminal device. In a conventional LoRaWAN, a terminal device determines a large quantity of parameters, and determines a receive window based on a complex local mechanism (a pingslot state machine). In at least one embodiment, the network device is useable to indicate a downlink time unit based on the first signal, and the terminal device can determine the downlink time unit without using the complex local mechanism, so that computing overheads and power consumption of the terminal device are reduced.

Optionally, the first signal further includes second indication information, and the second indication information is useable to indicate a length of each of the at least one time unit.

In comparison with a solution in which a length of each time unit is preset, a length of each time unit in the first time period can be flexibly set in this embodiment.

Optionally, the first signal further includes third indication information, and the third indication information is useable to indicate a quantity of the at least one time unit.

In comparison with a solution in which a quantity of time units is preset, a quantity of the time units in the first time period can be flexibly set in this embodiment.

Optionally, in response to the first time unit being useable for uplink transmission, the first signal further includes fourth indication information, and the fourth indication information is useable to indicate that the first time unit is not occupied.

In some cases, the first time unit may be useable for retransmission. The network device may indicate, based on indication information, whether the first time unit is occupied. For example, the network device is useable to indicate, based on the fourth indication information, that the first time unit is not occupied. In response to the terminal device not receiving the fourth indication information, the terminal device does not send the first data in the first time unit. In response to the terminal device receiving the fourth indication information, the terminal device may send the first data in the first time unit, or may determine, after performing channel monitoring, whether to send the first data in the first time unit. In this way, in response to the network device scheduling uplink transmission in the first time unit, the network device may indicate, based on the indication information, that the first time unit is occupied, to avoid a collision, and reduce monitoring power consumption of the terminal.

Optionally, in response to the first time unit being useable for uplink transmission, the at least one time unit in the first time period includes a plurality of time units, and the first time unit is any one of the plurality of time units.

In response to the first signal being useable to indicate the plurality of time units in the first time period, the terminal device may initiate access in any one of the plurality of time units, and no indication of the network device is relied upon, so that signaling overheads can be reduced.

Optionally, in response to the first time unit being useable for uplink transmission, the method further includes: sending a synchronization signal to the terminal device in the first time period.

In some cases, for example, in response to the terminal device being high in power, the network device may send the synchronization signal to the terminal device in the first time period, so that time synchronization between the terminal device and the network device is more accurate, and a probability that transmission fails is reduced.

Optionally, in response to the first time unit being useable for uplink transmission, the method further includes: sending a second signal to the terminal device, where the second signal is useable for time synchronization, the second signal is useable to indicate at least one time unit in a second time period, the at least one time unit in the second time period includes a second time unit useable for downlink communication, and the second time unit has an association relationship with the first time unit; and sending second data in the second time unit.

For example, the association relationship is that a location of the second time unit in the second time period is the same as a location of the first time unit in the first time period. Based on the association relationship, the terminal device may turn on a receive circuit in a part of the second time period (that is, the second time unit), and is able to not turn on the receive circuit in the entire second time period, so that power consumption of the terminal device can be reduced.

Optionally, the second data is feedback information of the first data. In response to the first data failing to be received, the method further includes: receiving the first data in a third time unit in a third time period, where the third time period is after the second time period, and the third time unit is useable for uplink transmission.

After transmission of the first data fails, in response to the terminal device retransmitting the first data at any moment in the third time period, a transmission collision is likely to occur to a great extent. In at least one embodiment, the terminal device retransmits the first data at a specific moment (that is, the third time unit) in the third time period, and the network device receives the first data at the specific moment (that is, the third time unit) in the third time period, to reduce a probability of a transmission collision.

Optionally, the method further includes: sending fifth indication information to the terminal device in the second time unit, where the fifth indication information is useable to indicate the third time unit.

The network device specifies, based on the fifth indication information, a dedicated time unit (that is, the third time unit) for the terminal device to retransmit the first data, so that a transmission collision can be avoided in response to the terminal device retransmitting the first data, thereby avoiding a power waste caused by a plurality of retransmissions.

According to a seventh aspect, at least one embodiment provides a communication apparatus. The apparatus may be a terminal device, or may be a chip in the terminal device. The communication apparatus may include a processing unit and a transceiver unit, configured to perform any one of the methods according to the first aspect and the implementations of the first aspect, or any one of the methods according to the third aspect and the implementations of the third aspect, or any one of the methods according to the fifth aspect and the implementations of the fifth aspect. The transceiver unit is a sending unit in response to performing a sending step, and the transceiver unit is a receiving unit in response to performing a receiving step.

According to an eighth aspect, at least one embodiment provides a communication apparatus. The apparatus may be a terminal device, or may be a chip in the terminal device. The communication apparatus may include a processor, configured to perform any one of the methods according to the first aspect and the implementations of the first aspect, or any one of the methods according to the third aspect and the implementations of the third aspect, or any one of the methods according to the fifth aspect and the implementations of the fifth aspect.

Optionally, the communication apparatus may further include a transceiver (for example, a transceiver circuit or an antenna).

Optionally, the communication apparatus may further include a memory (for example, a read-only memory or a random access memory). The memory is configured to store instructions, and the processor executes the instructions stored in the memory, to enable the communication apparatus to perform any one of the methods according to the first aspect and the implementations of the first aspect, or to enable the communication apparatus to perform any one of the methods according to the third aspect and the implementations of the third aspect, or to enable the communication apparatus to perform any one of the methods according to any the fifth aspect and the implementations of the fifth aspect.

Optionally, the communication apparatus may further include an interface circuit. The interface circuit may be an input/output interface, a pin, a circuit, or the like.

According to a ninth aspect, at least one embodiment provides a communication apparatus. The apparatus may be a network device, or may be a chip in the network device. The communication apparatus may include a processing unit and a transceiver unit, configured to perform any one of the methods according to the second aspect and the implementations of the second aspect, or any one of the methods according to the fourth aspect and the implementations of the fourth aspect, or any one of the methods according to the sixth aspect and the implementations of the sixth aspect. The transceiver unit is a sending unit in response to performing a sending step, and the transceiver unit being a receiving unit in response to performing a receiving step.

According to a tenth aspect, at least one embodiment provides a communication apparatus. The apparatus may be a network device, or may be a chip in the network device. The communication apparatus may include a processor, configured to perform any one of the methods according to the second aspect and the implementations of the second aspect, or any one of the methods according to the fourth aspect and the implementations of the fourth aspect, or any one of the methods according to the sixth aspect and the implementations of the sixth aspect.

Optionally, the communication apparatus may further include a transceiver (for example, a transceiver circuit or an antenna).

Optionally, the network device may further include a memory (for example, a read-only memory or a random access memory). The memory is configured to store instructions, and the processor executes the instructions stored in the memory, to enable the communication apparatus to perform any one of the methods according to the second aspect and the implementations of the second aspect, or to enable the communication apparatus to perform any one of the methods according to the fourth aspect and the implementations of the fourth aspect, or to enable the communication apparatus to perform any one of the methods according to the sixth aspect and the implementations of the sixth aspect.

Optionally, the communication apparatus may further include an interface circuit. The interface circuit may be an input/output interface, a pin, a circuit, or the like.

According to an eleventh aspect, at least one embodiment provides a computer-readable storage medium, where the computer-readable storage medium stores a computer program, and in response to the computer program being executed on a computer, the computer is enabled to perform any one of the methods according to the first aspect and the implementations of the first aspect, or the computer is enabled to perform any one of the methods according to the third aspect and the implementations of the third aspect, or the computer is enabled to perform any one of the methods according to the fifth aspect and the implementations of the fifth aspect.

According to a twelfth aspect, at least one embodiment provides a computer-readable storage medium. The computer-readable storage medium stores a computer program. In response to the computer program being executed on a computer, the computer is enabled to perform any one of the methods according to the second aspect and the implementations of the second aspect, or the computer is enabled to perform any one of the methods according to the fourth aspect and the implementations of the fourth aspect, or the computer is enabled to perform any one of the methods according to the sixth aspect and the implementations of the sixth aspect.

According to a thirteenth aspect, at least one embodiment provides a computer program product. The computer program product includes computer program code or computer program instructions. In response to the computer program code or the computer program instructions being run by a sidelink beam training apparatus, the apparatus is enabled to perform any one of the methods according to the first aspect and the implementations of the first aspect, or the apparatus is enabled to perform any one of the methods according to the third aspect and the implementations of the third aspect, or the apparatus is enabled to perform any one of the methods according to the fifth aspect and the implementations of the fifth aspect.

According to a fourteenth aspect, at least one embodiment provides a computer program product, where the computer program product includes computer program code or computer program instructions. In response to the computer program code or the computer program instructions being run by a sidelink beam training apparatus, the apparatus is enabled to perform any one of the methods according to the second aspect and the implementations of the second aspect, or the apparatus is enabled to perform any one of the methods according to the fourth aspect and the implementations of the fourth aspect, or the apparatus is enabled to perform any one of the methods according to the sixth aspect and the implementations of the sixth aspect.

### BRIEF DESCRIPTION OF DRAWINGS

FIG. 1 is a diagram of a communication system applicable to at least one embodiment;

FIG. 2 is a diagram of communication protocol stack of a LoRaWAN;

FIG. 3 is a diagram of a MAC-layer frame structure of a LoRaWAN;

FIG. 4 is a diagram of three transmission modes of a LoRaWAN;

FIG. 5 is a communication process in a Class B mode;

FIG. 6 is a diagram of a communication method according to at least one embodiment;

FIG. 7 is a diagram of a time domain resource according to at least one embodiment;

FIG. 8 is a diagram of another time domain resource according to at least one embodiment;

FIG. 9 is a diagram of another communication method according to at least one embodiment;

FIG. 10 is a diagram of a communication process of retransmission of first data according to at least one embodiment;

FIG. 11 is a diagram of another communication method according to at least one embodiment;

FIG. 12 is a diagram of LoRaWAN downlink transmission according to at least one embodiment;

FIG. 13 is a diagram of a structure of a communication apparatus according to at least one embodiment;

FIG. 14 is a diagram of a structure of a communication apparatus according to at least one embodiment;

FIG. 15 is a diagram of a structure of a communication apparatus according to at least one embodiment;

FIG. 16 is a diagram of a structure of a communication apparatus according to at least one embodiment;

FIG. 17 is a diagram of a structure of a terminal according to at least one embodiment; and

FIG. 18 is a diagram of a structure of a network device according to at least one embodiment.

### DESCRIPTION OF EMBODIMENTS

The following describes technical solutions of embodiments with reference to the accompanying drawings.

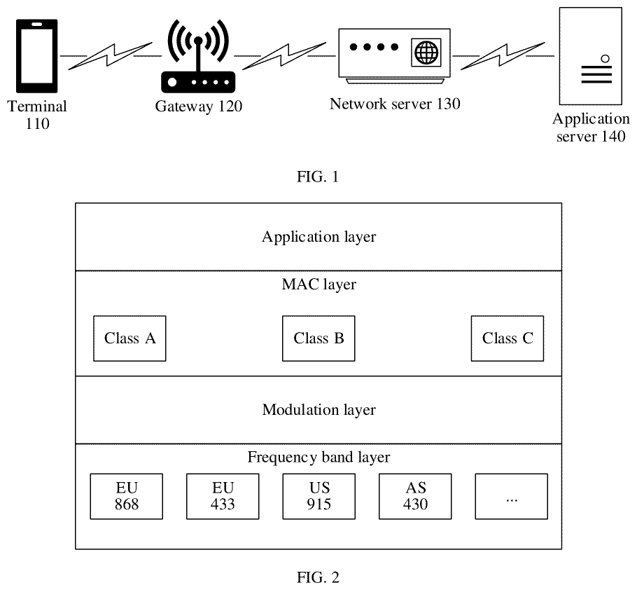

FIG. 1 is a diagram of a communication system applicable to at least one embodiment.

The communication system includes a terminal 110, a gateway 120, a network server 130, and an application server 140. The terminal 110 and the gateway 120 communicate with each other via a LoRaWAN. The gateway 120 and the network server 130 communicate with each other through a wireless connection (for example, a cellular network) or a wired connection (for example, an Ethernet backhaul network). The network server 130 and the application server 140 communicate with each other through a wired connection (for example, an Ethernet).

The LoRaWAN is a long-distance wireless network with low power consumption, scalability, high quality of service, and high security. A star topology structure is usually useable for the LoRaWAN, and the terminal 110 may communicate with one or more gateways through long range (long range, LoRa) modulation or frequency-shift keying (frequency-shift keying, FSK) modulation.

The terminal 110 is a device that provides data for a user, for example, a handheld device or an in-vehicle device that has a wireless connection function. The terminal 110 may be referred to as user equipment (user equipment, UE), and sometimes may also be referred to as a terminal device, an access station, a UE station, a remote station, or a wireless communication apparatus. The terminal 110 is also referred to as a node (node) or a sensor (sensor).

The terminal 110 may be a wireless terminal in industrial control (industrial control), a vehicle, a wireless communication module in a vehicle, a telematics box (telematics box, T-box), a road side unit (road side unit, RSU), a wireless terminal in self-driving, a smart speaker in an internet of things (internet of things, IoT), a wireless terminal device in telemedicine (remote medical), a wireless terminal device in a smart grid (smart grid), a wireless terminal device in transportation safety (transportation safety), a wireless terminal device in a smart city (smart city), a wireless terminal device in a smart home (smart home), or the like. This is not limited in at least one embodiment.

By way of example but not limitation, in embodiments of this application, the terminal 110 may alternatively be a wearable device. The wearable device may also be referred to as a wearable intelligent device, and is a general term for wearable devices, for example, glasses, gloves, a watch, clothing, and shoes, that are developed through smart design of daily wear by using a wearable technology. The wearable device is a portable device that can be directly worn on a body or integrated into clothes or accessories of a user. The wearable device is a hardware device, and also implements a powerful function through software support, data exchange, and cloud interaction. In a broad sense, the intelligent wearable device includes a full-featured and large-size electronic device, for example, smartwatch or smart glasses, that can implement complete or partial functions without depending on a smartphone, and includes an electronic device that is dedicated to only one type of application function and that is useable in cooperation with another device like the smartphone, for example, various smart bands or smart jewelry useable for vital sign measurement.

The gateway 120 is a network side device having a wireless transceiver function, and is an example of a network device. The gateway 120 is configured to: forward, to the terminal 110, data generated by the application server 140, and forward, to the network server 130, data generated by the terminal 110. There is no one-to-one correspondence between the terminal 110 and the gateway 120. The terminal 110 may be served by a plurality of gateways in an area, and uplink data of the terminal 110 may be received by all gateways that can receive the uplink data. In this way, a packet loss rate may be reduced.

The network device is a network side device having a wireless transceiver function. The network device may be an apparatus that is in a radio access network (radio access network, RAN) and that provides a wireless communication function for a terminal device, and is referred to as a RAN device. The RAN may be an access network in the 3rd generation partnership project (3rd generation partnership project, 3GPP), for example, a 4G network, a 5G network, or a future-oriented 6G network. The RAN may alternatively be an open radio access network (open RAN, O-RAN, or ORAN), a cloud radio access network (cloud radio access network, CRAN), or a communication network including the foregoing two or more networks. The RAN device may be a base station (base station), an evolved NodeB (evolved NodeB, eNodeB), a transmission reception point (transmission reception point, TRP), a next generation NodeB (next generation NodeB, gNB) in a 5th generation (5th generation, 5G) mobile communication system, a next generation base station in a 6th generation (6th generation, 6G) mobile communication system, a base station in a future mobile communication system, a wireless fidelity (wireless fidelity, Wi-Fi) system, or an access node in a long range radio (long range radio, LoRa) system or a vehicle-to-everything system. The RAN device may alternatively be a module or a unit that completes some functions of the base station, for example, may be a central unit (central unit, CU), or may be a distributed unit (distributed unit, DU), or may be a radio unit (radio unit, RU). The CU herein completes functions of a radio resource control protocol and a packet data convergence protocol (packet data convergence protocol, PDCP) of the base station, and may further complete a function of a service data adaptation protocol (service data adaptation protocol, SDAP). The DU completes functions of a radio link control layer and a medium access control (medium access control, MAC) layer of the base station, and may further complete some or all functions of a physical layer. For specific descriptions of the foregoing protocol layers, refer to related technical specifications in the 3rd generation partnership project (3rd generation partnership project, 3GPP). The CU and the DU may be separately arranged, or may be included in a same network element, for example, a baseband unit (baseband unit, BBU). The RU may be included in a radio frequency device or a radio frequency unit, for example, included in a remote radio unit (remote radio unit, RRU), an active antenna unit (active antenna unit, AAU), or a remote radio head (remote radio head, RRH). In different systems, the CU, the DU, or the RU may also have different names, and a person skilled in the art may understand meanings of the names. For example, in an ORAN system, the CU may also be referred to as an O-CU (open CU), the DU may also be referred to as an O-DU, and the RU may also be referred to as an O-RU. Any one of the CU (or a CU-CP or a CU-UP), the DU, and the RU in at least one embodiment may be implemented by using a software module, a hardware module, or a combination of a software module and a hardware module. The radio access network device may be a macro base station, or may be a micro base station or an indoor base station, or may be a relay node, a donor node, or the like. A specific technology and a specific device form that are useable for the radio access network device are not limited in at least one embodiment. For ease of description, the radio access network device is referred to as a network device for short, and the gateway 120 is useable as an example of the radio access network device.

The network server 130 is configured to: manage the LoRaWAN, and dynamically control a network parameter to enable the LoRaWAN to adapt to a changing condition. The network server 130 is further configured to: establish a secure connection between the terminal 110 and the application server 140, control traffic between the terminal 110 and the application server 140, and ensure authenticity of the terminal 110 and integrity of each message.

A wireless network between the gateway 120 and the network server 130 may be a communication system in the 3rd generation partnership project (3rd generation partnership project, 3GPP), for example, a wideband code division multiple access (wideband code division multiple access, WCDMA) system, a general packet radio service (general packet radio service, GPRS) system, an LTE system, a frequency division duplexing (frequency division duplexing, FDD) system, a time division duplex (time division duplexing, TDD) system, or a new radio (new radio, NR) system. The network between the gateway 120 and the network server 130 may alternatively be applied to a future communication system or a wireless communication system other than the 3GPP.

Functions of the application server 140 are processing, managing, and interpreting application data of the terminal 110 in a secure manner. A wired connection between the network server 130 and the application server 140 may be an optical fiber or a cable.

Specific types of the terminal 110, the gateway 120, the network server 130, and the application server 140 are not limited in at least one embodiment. In addition, a manner of communication between the gateway 120 and the network server 130 and a manner of communication between the network server 130 and the application server 140 are not limited in at least one embodiment.

A communication protocol stack of a LoRaWAN is shown in FIG. 2. From top to bottom, a LoRaWAN protocol is divided into four layers, which are respectively an application layer, a MAC layer, a modulation layer, and a frequency band layer.

The application layer is mainly responsible for generating and processing data. For example, the application layer may generate sensor data, and process instructions delivered by the gateway 120.

The MAC layer is mainly responsible for controlling a data link. For example, the MAC layer may encapsulate the data generated by the application layer, and then transmit the data to a physical layer.

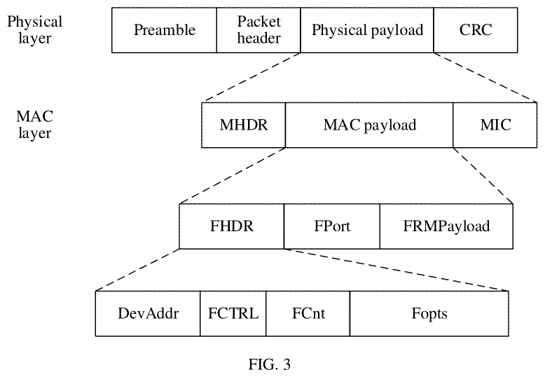

A MAC-layer frame structure of the LoRaWAN is shown in FIG. 3.

A MAC frame may include a MAC header (MAC header, MHDR), a MAC payload, and a message integrity code (message integrity code, MIC). The MHDR usually occupies one byte, and includes a frame type (frame type, FType), a protocol number (Major), and a reserved field. The MAC payload is a data frame, and may include a frame header (frame header, FHDR), a frame port (frame port, FPort), and a frame payload (frame payload, FRMPayload). The MIC usually occupies four bytes, and is useable for a data check for the MAC frame.

The FHDR may include a 4-byte terminal address (device address, DevAddr), 1-byte frame control (frame control, FCtrl), a 2-byte frame counter (frame counter, FCnt), and frame options (frame options, FOpts) useable for MAC command transmission.

The FRMPayload is a valid payload of the MAC frame, and may be useable to store a MAC command, or may be useable to store user data, for example, the sensor data generated by the application layer.

The MAC frame is encapsulated as a whole in a physical payload. The physical payload is located in a frame at the physical layer. The frame at the physical layer further includes a preamble, a packet header, and a cyclic redundancy check (cyclic redundancy check, CRC).

The modulation (modulation) layer is mainly responsible for data modulation and demodulation. For example, the modulation layer may use different spreading factors to provide different data transmission rates through chirp spread spectrum (chirp spread spectrum, CSS) modulation.

The frequency band layer is also referred to as a regional industrial scientific medical (industrial scientific medical, ISM) band layer, and is mainly responsible for transmission and receiving of a radio frequency signal. Frequency bands allocated to LoRaWANs in different regions are different. For example, frequency bands near 868 MHz and 433 MHz may be useable in Europe (EU), frequency bands near 915 MHz may be useable in US (US), and frequency bands near 430 MHz may be useable in Asia (AS). The modulation layer and the frequency band layer are also referred to as physical layers.

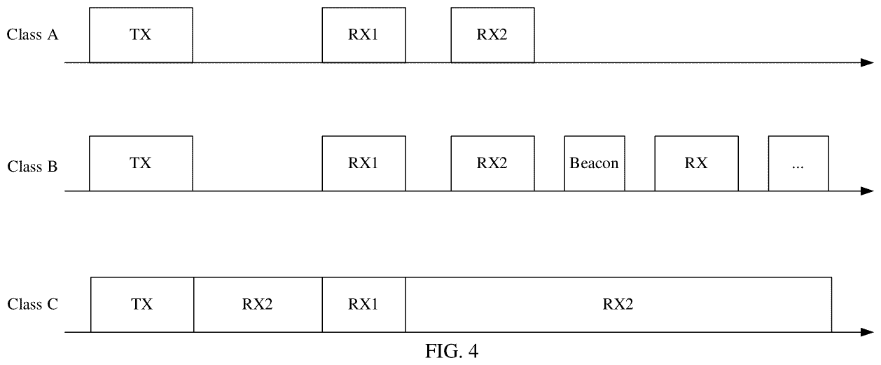

Based on different scenarios, the LoRaWAN has three transmission modes: Class A, Class B, and Class C. A specific transmission mode is implemented by the MAC layer. The following describes the three transmission modes with reference to FIG. 4.

Class A: A terminal in the Class A mode may initiate access at any time. After an uplink window (TX), one or two temporary downlink windows (RX1 and RX2) are enabled to receive data from a network. In response to no data being transmitted, the terminal is in a dormant state. Even in response to a gateway having downlink data for transmission, the terminal waits to enable a downlink window before transmission.

A frequency useable in RX1 is related to an uplink frequency, and a transmission rate useable in RX1 is related to an uplink rate. RX1 may be enabled 1 s±20 μs after uplink data sending is completed (the 1 s may be adjusted by using a parameter, and a common default value is 1). Generally, a downlink rate in RX1 is related to a last uplink channel transmission rate by default.

A fixed configurable frequency and a data transmission rate are useable in RX2. RX2 is enabled 2 s±20 μs after uplink data sending is completed (the 2 s may be adjusted by using a parameter, and a common default value is 2). The frequency and the data transmission rate useable in RX2 may be set by using a MAC command.

Duration of two receive windows are used at least to enable the terminal to detect a preamble of downlink data.

The Class A transmission mode provides a transmission mode with lowest power consumption is provided, and is usually useable for an internet of things device with low power consumption, for example, a plurality of sensors such as a water meter, a gas meter, a smoke sensor, and a door status sensor.

Class B: A terminal in the Class B mode has more receive windows, to receive more downlink data. The terminal receives, from a gateway, a beacon (Beacon) useable for time synchronization, to enable an additional receive window at specified time. Class B is generally useable in a scenario of downlink control and uses low power consumption, for example, a water gate, an air gate, and a door lock.

Class C: A terminal in the Class C mode keeps a receive window enabled and only temporarily disables the receive window during sending. 2^{nd} RX2 lasts until next uplink transmission. The terminal in the Class C mode consumes more power than terminals in the Class A and Class B modes, but a downlink transmission delay is the shortest. Generally, Class C is applicable to a scenario with long-term power supply, for example, an electricity meter and a street lamp.

Generally, after being started, a terminal joins a LoRaWAN in the Class A mode, and then an application layer of the terminal may choose to switch to the Class B mode or the Class C mode.

The following describes in detail a communication process in the Class B mode.

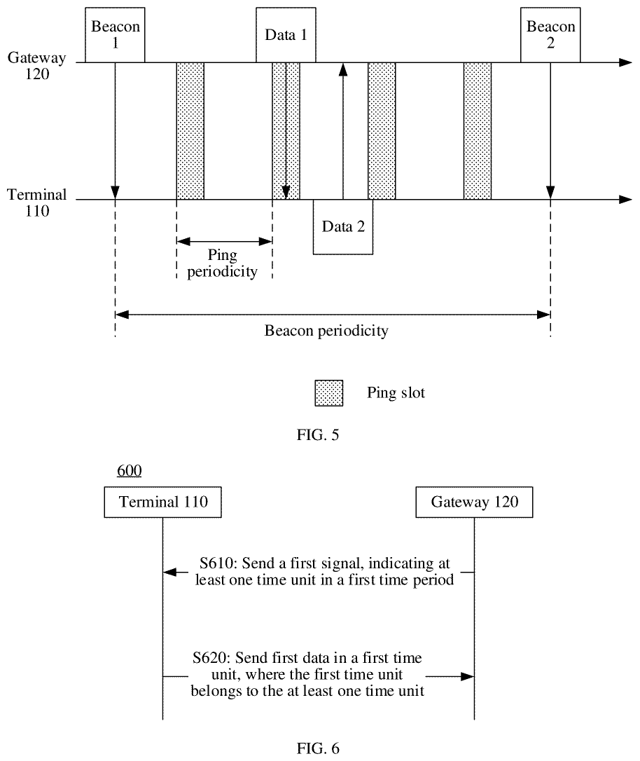

As shown in FIG. 5, after a terminal 110 switches to the Class B mode, the terminal 110 and an application server 140 agree on a parameter of a receive window. The application server 140 delivers data in the agreed receive window (a ping slot) via a gateway 120, and the terminal 110 receives the data in the agreed receive window. In addition, the gateway 120 periodically broadcasts a beacon, to keep time synchronization between the terminal 110 and the gateway 120.

For example, the terminal 110 and the application server 140 agree that four ping slots are set during one beacon periodicity, the terminal 110 enables four ping slots between a beacon 1 and a beacon 2, and the application server 140 sends data 1 to the terminal 110 in a 2^{nd} ping slot via the gateway 120. Correspondingly, the terminal 110 receives the data 1 in the 2^{nd} ping slot. Then, the terminal 110 may send data 2 to the gateway 120 at any moment except a window for receiving the beacon and the ping slot.

The foregoing mechanism for agreeing on the receive window is referred to as a pingslot state machine. In response to the terminal 110 using the pingslot state machine to determine a receive window, a location of the receive window can be estimated by using a large quantity of parameters and complex computing steps. As a result, the terminal 110 consumes a large amount of power, which is contrary to the purpose of low power consumption of the LoRaWAN. In addition, in a conventional LoRaWAN, once an amount of to-be-transmitted data reaches a threshold, the terminal 110 may immediately initiate access. However, there are usually a plurality of terminals within a coverage area of the gateway 120. In response to the terminal 110 initiating access at any moment, a transmission collision occurs. After the transmission collision occurs, the terminal 110 may immediately perform retransmission, causing frequent transmission collisions.

The following describes a communication method provided in at least one embodiment.

As shown in FIG. 6, a method 600 includes the following content.

S610: A gateway 120 sends a first signal to a terminal 110, where the first signal is useable for time synchronization, and the first signal is useable to indicate at least one time unit in a first time period (time period).

Correspondingly, the terminal 110 receives the first signal from the gateway 120. The first signal may be referred to as a beacon (beacon), a synchronization signal block (synchronization signal block, SSB), system information (system information, SI), a system information block (system information block, SIB), a master information block (master information block, MIB), a primary synchronization signal (primary synchronization signal, PSS), a secondary synchronization signal (secondary synchronization signal, SSS), a reference signal (reference signal, RS), a synchronization sequence, downlink control information (downlink control information, DCI), downlink data (downlink data), or the like. A specific name of the first signal is not limited in at least one embodiment. In an optional example, a periodicity of the first signal may be 128 milliseconds. In an optional example, due to device complexity or limited power consumption, an internal crystal oscillator of the terminal 110 generates a frequency offset, and the first signal can be useable to correct the frequency offset.

The time unit (time unit) may be referred to as a slot (slot), or may have another name. A specific name and a length of the time unit are not limited in at least one embodiment.

Unless otherwise specified, in this embodiment of this application, terms such as “first” and “second” are intended to distinguish between different objects. For example, the “first signal” and a “second signal” described below indicate different signals. There is no other limitation.

The first signal may implicitly or explicitly indicate the at least one time unit in the first time period, and the at least one time unit may be one time unit, or may be a plurality of time units.

In an optional example, the first signal includes a synchronization sequence (for example, a pilot sequence), and the synchronization sequence is useable for time synchronization.

In this case, different synchronization sequences may implicitly indicate different content, and examples are as follows:
the synchronization sequence may indicate a quantity, a location, and a length of the at least one time unit; or
the synchronization sequence may indicate a quantity and a location of the at least one time unit, and a length of the at least one time unit may be defined in a LoRaWAN protocol or configured by the gateway 120; or
the synchronization sequence may indicate a quantity and a length of the at least one time unit, and a location of the at least one time unit may be defined in a LoRaWAN protocol or configured by the gateway 120; or
the synchronization sequence may indicate a location and a length of the at least one time unit, and a quantity of the at least one time unit may be defined in a LoRaWAN protocol or configured by the gateway 120; or
the synchronization sequence may indicate a quantity of the at least one time unit, and a location and a length of the at least one time unit may be defined in a LoRaWAN protocol or configured by the gateway 120; or
the synchronization sequence may indicate a location of the at least one time unit, and a quantity and a length of the at least one time unit may be defined in a LoRaWAN protocol or configured by the gateway 120; or
the synchronization sequence may indicate a length of the at least one time unit, and a quantity and a location of the at least one time unit may be defined in a LoRaWAN protocol or configured by the gateway 120.

The synchronization sequence may further indicate a transmission direction (uplink or downlink) of the at least one time unit. The uplink transmission direction is useable to indicate that the terminal 110 may send an uplink signal in a first time unit, and the downlink transmission direction is useable to indicate that the terminal 110 may receive a downlink signal in the first time unit. The downlink signal received by the terminal 110 may be data, or may be a response message of uplink data in a previous window.

The synchronization sequence implicitly is useable to indicate the quantity, the location, the length, and the transmission direction of the at least one time unit, so that an amount of information carried by the first signal can be reduced, thereby reducing signaling overheads.

In an optional example, the first signal includes indication information, and the indication information is useable to indicate at least one of the following content of the at least one time unit: a quantity, a location, a length, and a transmission direction.

For example, the first signal includes at least one of first indication information, second indication information, third indication information, and sixth indication information, where the first indication information is useable to indicate that a first time unit is an uplink time unit or a downlink time unit, the second indication information is useable to indicate a length of each of the at least one time unit, the third indication information is useable to indicate the quantity of the at least one time unit, and the sixth indication information is useable to indicate the location of the at least one time unit.

In an optional example, the sixth indication information may indicate a time length between a start location of the first time unit and a start location or an end location of the first signal (for example, a quantity of frames or slots between the start location of the first time unit and the start location or the end location of the first signal).

The location of the at least one time unit may alternatively be implicitly indicated by a first message. For example, a LoRaWAN protocol may define that the start location of the first time unit is the end location of the first signal. Alternatively, the gateway 120 may configure that the start location of the first time unit is the end location of the first signal. Alternatively, there may be a mapping relationship, specified in a protocol, between the location of the at least one time unit and other indication information.

In an optional example, the first signal may further include seventh indication information, and the seventh indication information is useable to schedule uplink transmission of the terminal 110.

The seventh indication information may indicate at least one of the following content:
a maximum quantity of transmitted bits in each window, for example, a transport block size (transport block size, TBS) of 1 to 256 bytes may be indicated by using an 8-bit field;
whether the terminal can use convolutional code;
an uplink coverage level, for example, uplink coverage levels corresponding to different subcarrier spacings (subcarrier spacings, SCSs) and preamble (preamble) lengths;
a bit repetition count;
dormant time, to enable the terminal to initiate access or send data or receive data after waking up;
an uplink transmission bit rate;
an uplink preamble (preamble) length; and
whether a frequency shift can be useable.

The first indication information, the second indication information, the third indication information, the sixth indication information, and the seventh indication information may be carried in a MAC field. For example, the MAC field may be located in a MAC header (MAC subheader), a MAC control element (MAC control element, MAC CE), a reserved field of an MHDR, FOpts of an FHDR, or a MAC command of an FRMPayload. In addition, the first indication information, the second indication information, the third indication information, the sixth indication information, or the seventh indication information may be a plurality of fields, or may be one field. Specific forms of the first indication information, the second indication information, the third indication information, the sixth indication information, and the seventh indication information are not limited in at least one embodiment.

In an optional example, the first indication information may include a 1-bit binary field. For example, in response to the first indication information being 0, the first indication information is useable to indicate that the first time unit is the uplink time unit, and in response to the first indication information being 1,the first indication is useable to indicate that the first time unit is the downlink time unit.

In an optional example, the second indication information may indicate a time length of the at least one time unit, for example, 1 ms or 2 ms. The 2-bit second indication information is useable as an example. 00 may indicate 1 millisecond, 01 may indicate 2 milliseconds, 10 may indicate 3 milliseconds, and 11 may indicate 4 milliseconds. Alternatively, the second indication information may indicate a quantity of frames or slots. For example, the second indication information is useable to indicate that a length of the first time unit is one slot, two slots, or another quantity of slots; or the second indication information is useable to indicate that a first time length is one frame, two frames, or another quantity of frames. A specific quantity of slots or a specific quantity of frames may be specified in a protocol, or may be indicated by the gateway 120 or a network server 130.

In an optional example, the third indication information may indicate the quantity of the at least one time unit. For example, the third indication information may indicate that there are N consecutive time units from a time location indicated by the sixth indication information, where N is a positive integer.

In comparison with a solution in which an uplink time unit is determined based on a synchronization sequence, explicitly indicating the quantity, the location, and the length of the at least one time unit by using indication information does not pose an excessively high goal for a receiving capability of the terminal 110 and can reduce costs of the terminal 110. In addition, in comparison with a solution in which a quantity, a location, and a length of each time unit are preset, a quantity, a location, and a length of each time unit in the first time period can be further flexibly set in this embodiment.

The following uses an example in which the first time unit in the first time period is useable for uplink transmission for description.

S620: The terminal 110 sends first data to the gateway 120 in the first time unit, where the first time unit belongs to the at least one time unit.

Correspondingly, the gateway 120 receives the first data from the terminal 110 in the first time unit.

The first data may be to-be-sent data generated by an application layer. In an optional example, the at least one time unit in the first time period includes a plurality of time units, and the first time unit is any one of the plurality of time units.

In response to the first signal being useable to indicate the plurality of time units in the first time period, the terminal 110 may initiate access in any one of the plurality of time units in response to there being to-be-sent data, and no indication of the gateway 120 is used, so that signaling overheads can be reduced.

The terminal 110 may directly send the first data to the gateway 120 in the first time unit, or may determine, in one or more manners, whether the first time unit is occupied. In response to determining that the first time unit is not occupied, the terminal 110 sends the first data to the gateway 120 in the first time unit. In response to the first time unit having been occupied, the terminal 110 does not send the first data in the first time unit, so that a probability of a transmission collision can be reduced.

In an optional example, the terminal 110 may determine, through channel monitoring, whether the first time unit is occupied.

The terminal 110 may initiate access at any moment in the first time unit. Therefore, the terminal 110 may monitor a channel before sending the first data. In response to the terminal 110 detecting a signal of another terminal through monitoring, the terminal 110 may determine that the first time unit has been occupied, and the terminal 110 does not send the first data in the first time unit. In response to the terminal 110 detecting no signal (for example, a preamble sequence, a pulse signal, or uplink information) of another terminal, the terminal 110 may determine that the first time unit is not occupied.

In an optional example, the terminal 110 may determine, based on the first signal, whether the first time unit is occupied (where “occupy” may also be described as “reserve” or “configure”).

In some cases, the first time unit may be useable for retransmission. The gateway 120 may indicate, by using the indication information in the first signal, whether the first time unit is occupied. For example, the gateway 120 is useable to indicate, by using the fourth indication information, that the first time unit is not occupied. In response to the terminal 110 receiving no fourth indication information, the receipt of no fourth indication is useable to indicate that the first time unit has been occupied by a terminal for retransmission, then the terminal 110 does not send the first data in the first time unit, and the terminal 110 may send the first data in a next uplink time unit. In response to the terminal 110 receiving the fourth indication information, receipt of the fourth indication information is useable to indicate that the first time unit is not occupied by the terminal for retransmission, and then the terminal 110 may send the first data in the first time unit. Alternatively, the gateway 120 may indicate, by using a 1-bit field, whether the first time unit is occupied. For example, in response to the field being “1”, the first time unit is occupied, and in response to the field being “0”, the first time unit is not occupied.

Alternatively, the terminal 110 may determine, in a plurality of manners, whether the first time unit is occupied. For example, after receiving the fourth indication information, the terminal 110 may continue performing channel monitoring, and determine, based on a result of channel monitoring, whether to send the first data in the first time unit.

From the foregoing that, in the method 600, the terminal 110 determines an uplink time unit (for example, the first time unit) based on an indication of the gateway 120. Once the uplink time unit is occupied, or once a transmission collision occurs, the terminal 110 may wait for a next uplink time unit to perform transmission again, or monitor a next unoccupied time unit to perform transmission again, or perform transmission again based on an available time unit that is indicated by a network device (for example, the gateway or a base station). Because a transmission moment is no longer any moment, this embodiment can reduce a probability of a transmission collision, and improve access efficiency. In addition, in response to a current uplink time unit being occupied, the terminal 110 is able to not continue monitoring to a channel in the current uplink time unit. Therefore, this embodiment can also reduce monitoring power consumption of the terminal 110.

In the foregoing embodiment, the at least one time unit in the first time period may be all useable for uplink transmission, or may be all useable for downlink transmission. In response to the first time period including a plurality of time units, some of the plurality of time units may be useable for uplink transmission, and the remaining time units may be useable for downlink transmission. The gateway 120 may explicitly or implicitly indicate that the at least one time unit in the first time period is useable for uplink transmission or downlink transmission. For example, 1-bit field indication information is useable to indicate that the at least one time unit in the first time period is useable for uplink transmission or downlink transmission. For example, in response to the field being “1”, the at least one time unit in the first time period is useable for uplink transmission, and in response to the field being “0”, the at least one time unit in the first time period is useable for downlink transmission.

In addition, the at least one time unit in the first time period may be alternatively configured in a static configuration manner or a dynamic configuration manner. In response to configuration being performed in a static manner, a protocol may specify that an M^{th} time unit after a beacon is useable for uplink transmission, and an N^{th} time unit after the beacon is useable for downlink transmission; or the protocol may specify a sequence of an uplink time unit and a downlink time unit. In response to configuration being performed in a dynamic manner, a beacon may indicate one of at least one configuration manner. For example, a configuration manner indicated by the beacon may be that a 1^{st} time unit after the beacon is useable for uplink transmission, and subsequent several time units are useable for downlink transmission. Alternatively, the beacon is useable to indicate that uplink transmission should be performed in an X^{th} time unit. M, N, and X are all positive integers.

In some cases, for example, the terminal 110 may send a synchronization signal to the gateway 120 in the first time period, so that time synchronization between the terminal 110 and the gateway 120 is more accurate, and a probability that transmission fails is reduced.

The following describes diagrams of two time domain resources according to at least one embodiment.

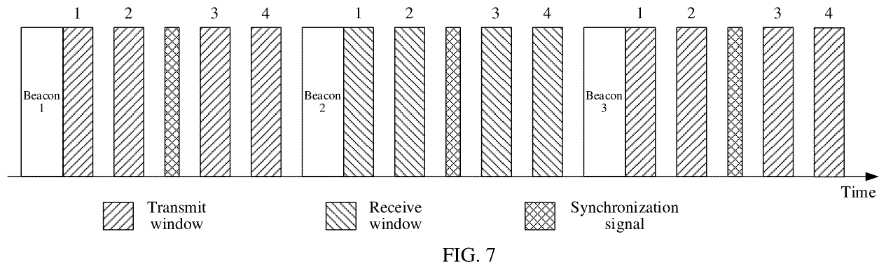

As shown in FIG. 7, a time period between two adjacent beacons includes four time units, and lengths of the four time units may be the same or may be different. In response to the four time units all being useable for uplink transmission, the four time units are transmit windows. In response to the four time units all being useable for downlink transmission, the four time units are receive windows. A time domain position of a synchronization signal may be any position between time domain positions corresponding to two adjacent beacons.

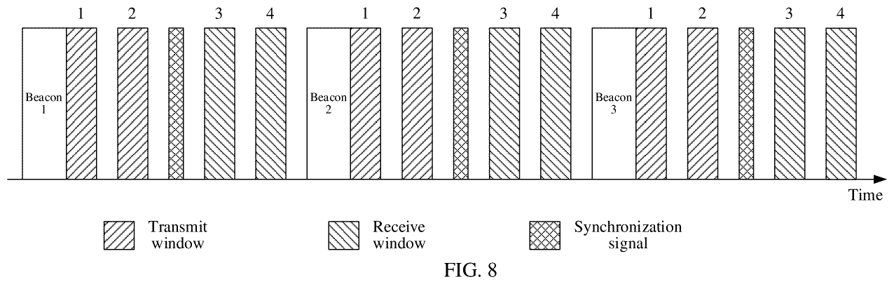

As shown in FIG. 8, a time period between two adjacent beacons includes four time units, and lengths of the four time units may be the same or may be different. In the four time units, first two time units are useable for uplink transmission, and last two time units are useable for downlink transmission. In other words, the first two time units are transmit windows, and the last two time units are receive windows. A time domain position of a synchronization signal may be any position between time domain positions corresponding to two adjacent beacons.

After sending the first data in the first time period, the terminal 110 may receive, in a second time period, second data sent by the gateway 120. In response to the second data being feedback information of the first data, the terminal 110 further determines, based on the feedback information, whether to retransmit the first data.

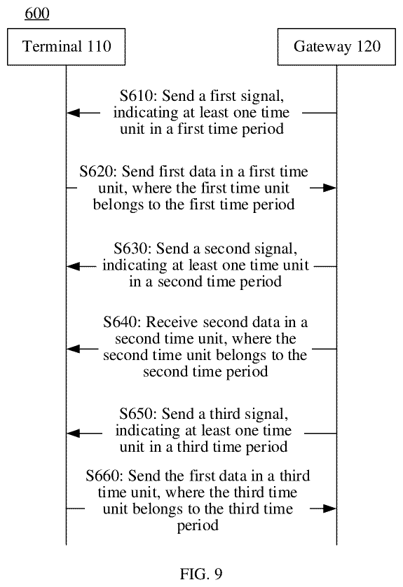

As shown in FIG. 9, the method 600 further includes the following content.

S630: The gateway 120 sends a second signal to the terminal 110, where the second signal is useable to indicate at least one time unit in the second time period.

Correspondingly, the terminal 110 receives the second signal from the gateway 120.

The second signal is useable for time synchronization.

A function of the second signal is similar to a function of the first signal, and details are not described herein again.

S640: The gateway 120 sends the second data to the terminal 110 in a second time unit, where the second time unit belongs to the second time period, and the second time unit has an association relationship with the first time unit.

Correspondingly, the terminal 110 receives the second data from the gateway 120.

For example, the association relationship is that a location of the second time unit in the second time period is the same as a location of the first time unit in the first time period, or a number (or an identifier) of the second time unit is the same as a number (or an identifier) of the first time unit. Based on the association relationship, the terminal 110 may turn on a receive circuit in a part of the second time period (that is, the second time unit), and is able to not turn on the receive circuit in the entire second time period, so that power consumption of the terminal 110 can be reduced.

In an optional example, the second data is the feedback information of the first data. In response to the feedback information being useable to indicate that transmission of the first data succeeds, the terminal 110 may go to sleep, or may continue receiving data or wait for a next uplink time unit to transmit new data. In response to the feedback information being useable to indicate that transmission of the first data fails, the terminal 110 may wait for a next uplink time unit to retransmit the first data.

The method 600 further includes the following:
S650: The gateway 120 sends a third signal to the terminal 110, where the third signal is useable for time synchronization, and the third signal is useable to indicate at least one time unit in a third time period.

Correspondingly, the terminal 110 receives the third signal from the gateway 120.

A function of the third signal is similar to a function of the first signal, and details are not described herein again.

S660: The terminal 110 sends the first data to the gateway 120 in a third time unit, where the third time unit belongs to the third time period, and the third time unit is useable for uplink transmission.

In response to the terminal 110 receiving no feedback information in the second time unit, or in response to the feedback information being is useable to indicate that data transmission fails, the terminal 110 retransmits the first data in the third time unit in the third time period.

After transmission of the first data fails, in response to the terminal 110 retransmitting the first data at any moment in the third time period, a transmission collision is likely to occur to a great extent. In this example, the terminal 110 retransmits the first data at a specific moment (that is, the third time unit) in the third time period, to reduce a probability of transmission collision.

The third time unit may be a time unit specially useable for retransmission, and the gateway 120 may indicate that the second time unit is useable for retransmission.

For example, the gateway 120 may send fifth indication information to the terminal 110 in the second time unit, where the fifth indication information includes an identifier of the third time unit, to indicate that the third time unit is useable for retransmission. The fifth indication information may be sent at the same time as the second data, or may be sent independently. Both a specific form of and a transmission manner for the fifth indication information are not limited in at least one embodiment.

The gateway 120 specifies, based on the fifth indication information, a dedicated time unit (that is, the third time unit) for the terminal 110 to retransmit the first data, so that a transmission collision can be avoided in response to the terminal 110 retransmitting the first data, thereby avoiding a power waste caused by a plurality of retransmissions.

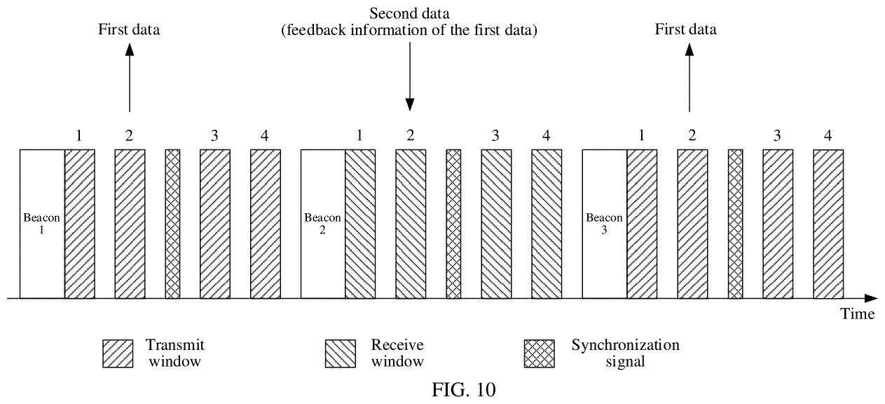

FIG. 10 is a diagram of a communication process of retransmission of the first data according to at least one embodiment.

After receiving a beacon 1, the terminal 110 determines, based on the beacon 1, that there are four transmit windows (that is, four transmit windows between the beacon 1 and a beacon 2) after the beacon 1. Before a transmit window 2, in response to an amount of to-be-sent data generated by the terminal 110 reaching a threshold, the terminal 110 may determine, through channel monitoring or another manner, whether the transmit window 2 has been occupied. In response to the terminal 110 determining that the transmit window 2 is not occupied, the terminal 110 sends the first data to the gateway 120 in the transmit window 2.

The gateway 120 determines, at the transmit window 2, that there is a collision (a plurality of terminals perform access in a same slot), and may send the fifth indication information at a receive window (a receive window 2) corresponding to the transmit window 2, to indicate a terminal subject to the collision at the transmit window 2 to perform retransmission in some transmit windows in a next uplink time period. For example, in response to the fifth indication information being converted into a decimal value “1”, a time window 1 after a beacon 3 is useable for retransmission. In response to the fifth indication information being converted into a decimal value “2”, the time window 1 and a time window 2 after the beacon 3 are useable for retransmission.

Then, the terminal 110 receives the beacon 2, and determines, based on the beacon 2, that there are four receive windows (that is, four receive windows between the beacon 2 and the beacon 3) after the beacon 2. The terminal 110 may determine, based on a number of a transmit window useable for sending the first data, a number of a receive window for receiving the feedback information. In other words, the terminal 110 determines to receive the feedback information of the first data at the receive window 2.

Optionally, in response to the feedback information of the first data being a negative acknowledgment (non acknowledgement, NACK), the terminal 110 determines that transmission of the first data fails, and the terminal 110 prepares to retransmit the first data. The second data may alternatively include the fifth indication information, to indicate specific transmit windows in a next time period that are useable for retransmission. For example, in response to the fifth indication information being an identifier of the transmit window 2, the terminal 110 may determine, based on the fifth indication information, that transmit windows (that is, the transmit window 1 and the transmit window 2 after the beacon 3) before the transmit window 2 are useable for retransmission, and the terminal 110 may retransmit the first data at the transmit window 1 or the transmit window 2 after the beacon 3. A specific manner in which the terminal 110 retransmits the first data is not limited in at least one embodiment.

The gateway 120 may include the identifier of the transmit window 2 in the beacon 3, to indicate that the transmit window 1 and the transmit window 2 after the beacon 3 are unavailable. In this way, another terminal does not send data in the transmit window 1 and the transmit window 2 after the beacon 3, thereby avoiding a transmission collision.

The following describes another communication method provided in at least one embodiment.

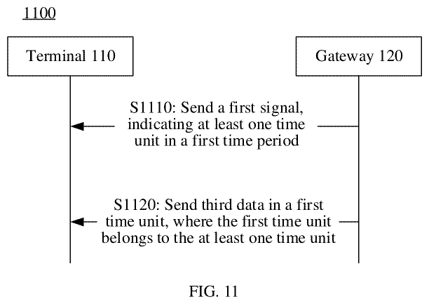

As shown in FIG. 11, a method 1100 includes the following content.

S1110: A gateway 120 sends a first signal to a terminal 110, where the first signal is useable for time synchronization, and the first signal is useable to indicate at least one time unit in a first time period.

Correspondingly, the terminal 110 receives the first signal from the gateway 120. For a function of the first signal in the method 1100, refer to the function of the first signal in the method 600. For example, the first signal may include at least one of first indication information, second indication information, and third indication information. Details are not described again.

The following uses an example in which a first time unit in the first time period is useable for downlink transmission for description.

S1120: The gateway 120 sends third data to the terminal 110 in the first time unit, where the first time unit belongs to the at least one time unit.

Correspondingly, the terminal 110 receives the third data from the gateway 120 in the first time unit.

The third data may be data generated by an application server 140. In an optional example, the at least one time unit in the first time period includes a plurality of time units, and the first time unit is any one of the plurality of time units. In response to the first signal being useable to indicate the plurality of time units in the first time period, the terminal 110 may turn on a receive circuit in any one of the plurality of time units for receiving.

In a conventional LoRaWAN, the terminal 110 determines a large quantity of parameters, and determine a receive window based on a complex local mechanism (a pingslot state machine). In at least one embodiment, the gateway 120 is useable to indicate a downlink time unit based on the first signal, and the terminal 110 can determine the downlink time unit without using the complex local mechanism, so that computing overheads and power consumption of the terminal 110 are reduced.

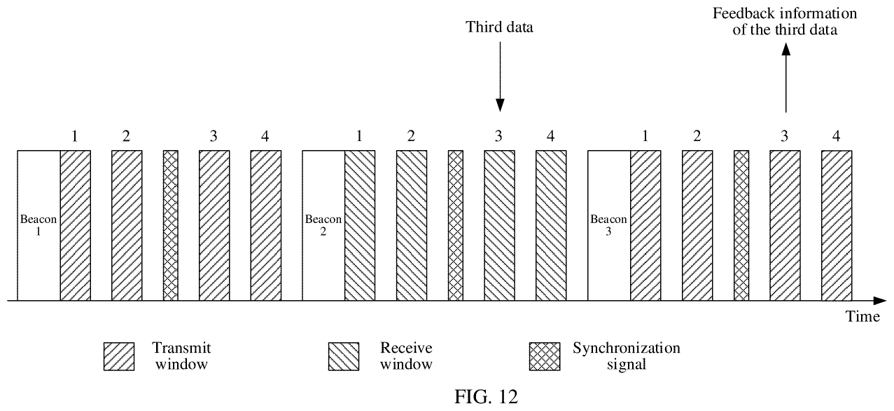

FIG. 12 is a diagram of LoRaWAN downlink transmission according to at least one embodiment.

The gateway 120 is useable to indicate, by using a beacon 2, four time units in the first time period (a time period between the beacon 2 and a beacon 3), and lengths of the four time units may be the same or may be different. In response to the four time units being all useable for downlink transmission, the four time units are receive windows.

After receiving the beacon 2, the terminal 110 determines, based on the beacon 2, that there are four receive windows after the beacon 2. Then, the terminal 110 may turn on a receive circuit at time domain positions of the four receive windows to receive a signal. In response to the gateway 120 sending third data at a receive window 3, the terminal 110 may receive the third data at the receive window 3. The terminal 110 may send feedback information to the gateway 120 in a subsequent uplink time unit.

After receiving the beacon 3, the terminal 110 determines, based on the beacon 3, that there are four transmit windows after the beacon 3. In this case, the terminal 110 may send the feedback information in any one of the four transmit windows. Optionally, the terminal 110 may send a NACK or an acknowledgment (acknowledgement, ACK) in a transmit window that has an association relationship with the receive window 3.

For example, the association relationship is that a location of the transmit window in a second time period (a time period after the beacon 3) is the same as a location of the receive window in the first time period, or a number (or an identifier) of the transmit window is the same as a number (or an identifier) of the receive window. Based on the association relationship, the terminal 110 may determine to send the feedback information in a transmit window 3.

The foregoing describes in detail the method examples provided in at least one embodiment. To implement the foregoing functions, a corresponding apparatus includes corresponding hardware structures and/or software modules for performing the functions. A person skilled in the art should be readily aware that, with reference to the units and algorithm steps in the examples described in embodiments disclosed herein, at least one embodiment can be implemented by hardware or a combination of hardware and computer software. Whether a function is performed by hardware or hardware driven by computer software depends on a particular application and a design constraint condition of the technical solutions. A person skilled in the art may use different methods to implement the described functions for each particular embodiment, but the embodiments described herein should not be understood to go beyond the scope of embodiments described herein.

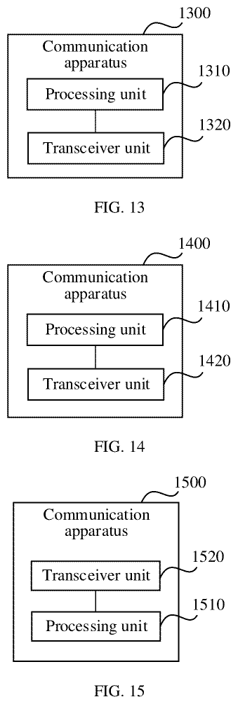

FIG. 13 is a diagram of a structure of a communication apparatus according to at least one embodiment. An apparatus 1300 includes a processing unit 1310 and a transceiver unit 1320. The transceiver unit 1320 performs a receiving step or a sending step under control of the processing unit 1310. The transceiver unit 1320 is a sending unit in response to performing the sending step, and the transceiver unit 1320 being a receiving unit in response to performing the receiving step.

The transceiver unit 1320 is configured to receive a first signal from a network device, where the first signal is useable for time synchronization, and the first signal is useable to indicate at least one time unit of a first time period.

The transceiver unit 1320 is further configured to send first data to the network device in a first time unit, where the first time unit is one of the at least one time unit.

For example, before sending the first data to the network device in the first time unit, the processing unit 1310 is configured to determine that the first time unit is not occupied.

For example, the processing unit 1310 is specifically configured to determine, through channel monitoring, that the first time unit is not occupied.

For example, the first signal includes fourth indication information, the fourth indication information is useable to indicate that the first time unit is not occupied, and the processing unit 1310 is configured to determine, based on the fourth indication information, that the first time unit is not occupied.

For example, the first signal includes first indication information, and the first indication information is useable to indicate that the first time unit is an uplink time unit.

For example, the first signal includes second indication information, and the second indication information is useable to indicate a length of each of the at least one time unit.

For example, the first signal includes third indication information, and the third indication information is useable to indicate a quantity of the at least one time unit.

For example, the at least one time unit in the first time period includes a plurality of time units, and the first time unit is any one of the plurality of time units.

For example, the transceiver unit 1320 is further configured to receive a synchronization signal from the network device in the first time period.

For example, the transceiver unit 1320 is further configured to: receive a second signal from the network device, where the second signal is useable for time synchronization, the second signal is useable to indicate at least one time unit in a second time period, the at least one time unit in the second time period includes a second time unit useable for downlink transmission, and the second time unit has an association relationship with the first time unit; and receive second data in the second time unit.

For example, the second data is feedback information of the first data. The transceiver unit 1320 is further configured to: in response to the feedback information not being received in the second time unit, or in response to the feedback information being useable to indicate that data transmission fails, retransmit the first data in a third time unit in a third time period, where the third time period is after the second time period, and the third time unit is useable for uplink transmission.

For example, the transceiver unit 1320 is further configured to receive fifth indication information from the network device in the second time unit, where the fifth indication information is useable to indicate the third time unit.

A person skilled in the art that understands for a detailed working process of the apparatus 1300 and technical effects generated by the execution steps, refer to the descriptions in the foregoing corresponding method embodiments. For brevity, details are not described herein again.

The apparatus 1300 may be a terminal or a chip. The processing unit 1310 may be implemented by hardware or software. In response to the processing unit 1310 being implemented by hardware, the processing unit 1310 may be a logic circuit, an integrated circuit, or the like. In response to the processing unit 1310 being implemented by software, the processing unit 1310 may be a general-purpose processor, and is implemented by reading software code stored in a storage unit. The storage unit may be integrated in the processing unit 1310, or located outside the processing unit 1310 and exist independently.

FIG. 14 is a diagram of a structure of another communication apparatus according to at least one embodiment. An apparatus 1400 includes a processing unit 1410 and a transceiver unit 1420. The transceiver unit 1420 performs a receiving step or a sending step under control of the processing unit 1410. The transceiver unit 1420 is a sending unit in response to performing the sending step, and the transceiver unit 1420 is a receiving unit in response to performing the receiving step.

The transceiver unit 1420 is configured to send a first signal to a terminal device, where the first signal is useable for time synchronization, and the first signal is useable to indicate at least one time unit in a first time period.

The transceiver unit 1420 is further configured to receive first data from the terminal device in a first time unit in the at least one time unit.

For example, the first signal includes first indication information, and the first indication information is useable to indicate that the first time unit is an uplink time unit.

For example, the first signal includes second indication information, and the second indication information is useable to indicate a length of each of the at least one time unit.

For example, the first signal includes third indication information, and the third indication information is useable to indicate a quantity of the at least one time unit.

For example, the first signal includes fourth indication information, and the fourth indication information is useable to indicate that the first time unit is not occupied.

For example, the at least one time unit in the first time period includes a plurality of time units, and the first time unit is any one of the plurality of time units.

For example, the transceiver unit 1420 is further configured to send a synchronization signal to the terminal device in the first time period.

For example, the transceiver unit 1420 is further configured to: send a second signal to the terminal device, where the second signal is useable for time synchronization, the second signal is useable to indicate at least one time unit in a second time period, the at least one time unit in the second time period includes a second time unit useable for downlink communication, and the second time unit has an association relationship with the first time unit; and send second data in the second time unit.

For example, the second data is feedback information of the first data. In response to the first data failing to be received, the transceiver unit 1420 is further configured to receive the first data in a third time unit in a third time period, where the third time period is after the second time period, and the third time unit is useable for uplink transmission.

For example, the transceiver unit 1420 is further configured to send fifth indication information to the terminal device in the second time unit, where the fifth indication information is useable to indicate the third time unit.

The apparatus 1400 may be a gateway or a chip. The processing unit 1410 may be implemented by hardware or software. In response to the processing unit 1410 being implemented by hardware, the processing unit 1410 may be a logic circuit, an integrated circuit, or the like. In response to the processing unit 1410 being implemented by software, the processing unit 1410 may be a general-purpose processor, and is implemented by reading software code stored in a storage unit. The storage unit may be integrated in the processing unit 1410, or located outside the processing unit 1410 and exist independently.

FIG. 15 is a diagram of a structure of another communication apparatus according to at least one embodiment. An apparatus 1500 includes a processing unit 1510 and a transceiver unit 1520. The transceiver unit 1520 performs a receiving step or a sending step under control of the processing unit 1510. The transceiver unit 1520 is a sending unit in response to performing the sending step, and the transceiver unit 1520 being a receiving unit in response to performing the receiving step.

The transceiver unit 1520 is configured to: receive a first signal from a network device, where the first signal is useable for time synchronization, and the first signal is useable to indicate at least one time unit in a first time period; and receive third data from the network device in a first time unit, where the first time unit is one of the at least one time unit.

For example, the first signal includes first indication information, and the first indication information is useable to indicate that the first time unit is a downlink time unit.

For example, the first signal includes second indication information, and the second indication information is useable to indicate a length of each of the at least one time unit.

For example, the first signal includes third indication information, and the third indication information is useable to indicate a quantity of the at least one time unit.

The apparatus 1500 may be a terminal or a chip. The processing unit 1510 may be implemented by hardware or software. In response to the processing unit 1510 being implemented by hardware, the processing unit 1510 may be a logic circuit, an integrated circuit, or the like. In response to the processing unit 1510 being implemented by software, the processing unit 1510 may be a general-purpose processor, and is implemented by reading software code stored in a storage unit. The storage unit may be integrated in the processing unit 1510, or located outside the processing unit 1510 and exist independently.

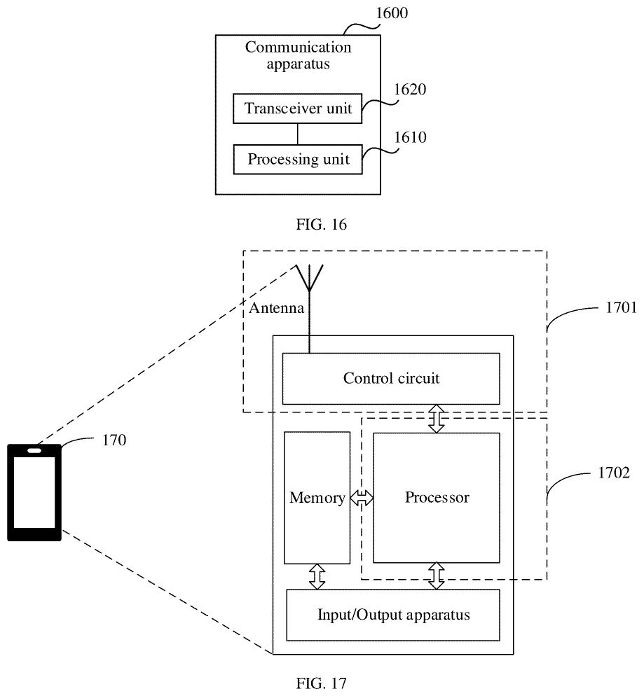

FIG. 16 is a diagram of a structure of another communication apparatus according to at least one embodiment. An apparatus 1600 includes a processing unit 1610 and a transceiver unit 1620. The transceiver unit 1620 performs a receiving step or a sending step under control of the processing unit 1610. The transceiver unit 1620 is a sending unit in response to performing the sending step, and the transceiver unit 1620 being a receiving unit in response to performing the receiving step.

The transceiver unit 1620 is configured to: send a first signal to a terminal device, where the first signal is useable for time synchronization, and the first signal is useable to indicate at least one time unit in a first time period; and send third data to the terminal device in a first time unit, where the first time unit is one of the at least one time unit.

For example, the first signal includes first indication information, and the first indication information is useable to indicate that the first time unit is a downlink time unit.

For example, the first signal includes second indication information, and the second indication information is useable to indicate a length of each of the at least one time unit.

For example, the first signal includes third indication information, and the third indication information is useable to indicate a quantity of the at least one time unit.

The apparatus 1600 may be a gateway or a chip. The processing unit 1610 may be implemented by hardware or software. In response to the processing unit 1610 being implemented by hardware, the processing unit 1610 may be a logic circuit, an integrated circuit, or the like. In response to the processing unit 1610 is implemented by software, the processing unit 1610 may be a general-purpose processor, and is implemented by reading software code stored in a storage unit. The storage unit may be integrated in the processing unit 1610, or located outside the processing unit 1610 and exist independently.

FIG. 17 is a diagram of a structure of a terminal according to at least one embodiment. For ease of description, FIG. 17 merely shows main components of the terminal. As shown in the figure of the device, a terminal 170 includes a processor, a memory, a control circuit, an antenna, and an input/output apparatus. The processor is mainly configured to: process a communication protocol and communication data, control the entire terminal, execute a software program, and process data of the software program, for example, is configured to support the terminal in performing the actions described in the foregoing method embodiments. The memory is mainly configured to store the software program and data. The control circuit is mainly configured to:
perform conversion between a digital signal and a radio frequency signal, and process the radio frequency signal. The control circuit and the antenna together may also be referred to as a transceiver, and is mainly configured to send and receive a radio frequency signal that is in an electromagnetic wave form. The input/output apparatus, for example, a touchscreen, a display, or a keyboard, is mainly configured to: receive data input by a user, and output data to the user.

After the terminal is powered on, the processor may read the software program in the memory, interpret and execute instructions of the software program, and process the data of the software program. In response to data being sent in a wireless manner, the processor performs processing on the to-be-sent data, and then outputs a digital signal to a radio frequency circuit. The radio frequency circuit performs radio frequency processing on the digital signal, and then sends, in an electromagnetic wave form and by using the antenna, a radio frequency signal to the outside. In response to data being sent to the terminal, the radio frequency circuit receives a radio frequency signal by using the antenna, converts the radio frequency signal into a digital signal, and outputs the digital signal to the processor. The processor converts the digital signal into data, and processes the data.

A person skilled in the art may understand that, for ease of description, FIG. 17 shows only one memory and one processor. In an actual terminal, there may be a plurality of processors and a plurality of memories. The memory may also be referred to as a storage medium, a storage device, or the like. This is not limited in at least one embodiment.

In at least one embodiment, the processor may include a baseband processor and/or a central processing unit. The baseband processor is mainly configured to process the communication protocol and the communication data. The central processing unit is mainly configured to: control the entire terminal, execute the software program, and process the data of the software program. The processor in FIG. 17 may integrate functions of the baseband processor and the central processing unit. A person skilled in the art may understand that the baseband processor and the central processing unit may be processors independent of each other, and are interconnected by using a technology, for example, through a bus. A person skilled in the art may understand that the terminal may include a plurality of baseband processors to adapt to different network standards, and the terminal may include a plurality of central processing units to enhance a processing capability of the terminal. All components of the terminal may be connected through various buses. The baseband processor may alternatively be expressed as a baseband processing circuit or a baseband processing chip. The central processing unit may alternatively be expressed as a central processing circuit or a central processing chip. A function of processing the communication protocol and the communication data may be built in the processor, or may be stored in the memory in a form of a software program, and the processor executes the software program to implement a baseband processing function.

In at least one embodiment, the antenna and the control circuit that have transceiver functions may be considered as a transceiver unit 1701 of the terminal device 170, for example, configured to support the terminal in implementing the receiving function and the sending function in the method embodiments. The processor having a processing function is considered as a processor 1702 of the terminal 170. The terminal 170 includes the transceiver unit 1701 and the processor 1702. The transceiver unit 1701 may also be referred to as a transceiver, a transceiver machine, a transceiver apparatus, or the like. For example, a component that is configured to implement the receiving function and that is in the transceiver unit 1701 may be considered as a receiving unit, and a component that is configured to implement the sending function and that is in the transceiver unit 1701 may be considered as a sending unit. In other words, the transceiver unit 1701 includes the receiving unit and the sending unit. The receiving unit may also be referred to as a receiver, an input port, a receive circuit, or the like. The sending unit may be referred to as a transmitter machine, a transmitter, a transmitting circuit, or the like. For example, the transceiver unit 1701 may not include the antenna, but includes only the circuit part, so that the antenna is arranged outside the transceiver unit.

The processor 1702 may be configured to execute instructions stored in the memory, so as to control the transceiver unit 1701 to receive a signal and/or send a signal, and complete functions of the terminal in the foregoing method embodiments. In at least one embodiment, the functions of the transceiver unit 1701 may be implemented through a transceiver circuit or a dedicated transceiver chip. In response to sending and receiving various types of signals, the processor 1702 controls the transceiver unit 1701 to implement receiving. Therefore, the processor 1702 makes a decision about sending or receiving a signal, and initiates data sending and receiving operations. The transceiver unit 1701 is an execution body of sending or receiving the signal.

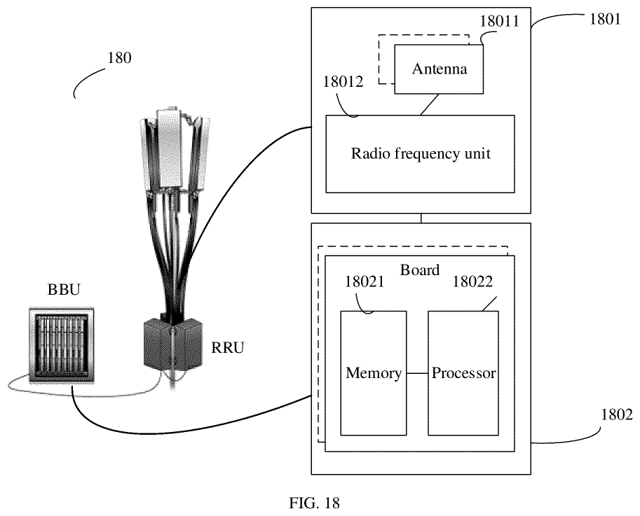

FIG. 18 is a diagram of a structure of a network device according to at least one embodiment. The network device may be, for example, a base station, and performs the steps of the gateway in the foregoing method embodiments. A base station 180 may include one or more radio frequency units, for example, a remote radio unit (remote radio unit, RRU) 1801 and one or more baseband units (baseband units, BBUs) (also referred to as distributed units (distributed units, DUs)) 1802. The RRU 1801 may be referred to as a transceiver unit, a transceiver machine, a transceiver circuit, a transceiver, or the like, and may include at least one antenna 18011 and a radio frequency unit 18012. The RRU 1801 is mainly configured to: send and receive a radio frequency signal, and perform conversion between a radio frequency signal and a baseband signal. The BBU 1802 is mainly configured to: perform baseband processing, control the base station, and so on. The RRU 1801 and the BBU 1802 may be physically disposed together, or may be physically disposed separately, that is, disposed in a distributed base station.

As a control center of the base station, the BBU 1802 may also be referred to as a processing unit, and is mainly configured to complete baseband processing functions such as channel coding, multiplexing, modulation, and spectrum spreading. For example, the BBU 1802 may be configured to control the base station to perform the operation procedure related to the network apparatus in the foregoing method embodiments.

In an embodiment, the BBU 1802 may include one or more boards. A plurality of boards may jointly support a radio access network (for example, a LoRaWAN) with a single access indication, or may respectively support radio access networks (for example, the LoRaWAN and an NR network) of different access standards. The BBU 1802 further includes a memory 18021 and a processor 18022. The memory 18021 is configured to store instructions and data. The processor 18022 is configured to control the base station to perform an action, for example, is configured to control the base station to perform an operation procedure related to the network apparatus in the foregoing method embodiments. The memory 18021 and the processor 18022 may serve the one or more boards. In other words, a memory and a processor may be disposed on each board. Alternatively, the plurality of boards may share a same memory and a same processor. In addition, a circuit may further be disposed on each board.

The processor in at least one embodiment may be an integrated circuit chip, and has a signal processing capability. In at least one embodiment, the steps in the foregoing method embodiments may be completed through an integrated logic circuit of the hardware in the processor or by using instructions in a form of software. The foregoing processor may be a general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate, a transistor logic device, or a discrete hardware component, and may implement or execute the methods, the steps, and logical block diagrams disclosed in at least one embodiment. The general-purpose processor may be a microprocessor, or the processor may be any conventional processor or the like. The steps of the method disclosed with reference to at least one embodiment may be directly performed and completed by a hardware decoding processor, or may be performed and completed by using a combination of a hardware module and a software module in the decoding processor. The software module may be located in a mature storage medium in the art, for example, a random access memory, a flash memory, a read-only memory, a programmable read-only memory, an electrically erasable programmable memory, or a register. The storage medium is located in the memory. The processor reads information in the memory, and completes the steps of the foregoing method together with the hardware of the processor.

The memory in at least one embodiment may be a volatile memory or a non-volatile memory, or may include both a volatile memory and a non-volatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is useable as an external cache. Through example but not limitative description, many forms of RAMs may be useable, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus dynamic random access memory (direct rambus RAM, DR RAM). The memory of the system and method described in at least one embodiment includes but is not limited to these memories and any other memory of a proper type.

For example, the chip in at least one embodiment may be a field programmable gate array (field-programmable gate array, FPGA), an application-specific integrated chip (application-specific integrated circuit, ASIC), a system on chip (system on chip, SoC), a central processing unit (central processing unit, CPU), a network processor (network processor, NP), a digital signal processing circuit (digital signal processor, DSP), a micro controller unit (micro controller unit, MCU), a programmable controller (programmable logic device, PLD), or another integrated chip.

In at least one embodiment, the steps of the foregoing method may be completed through an integrated logic circuit of the hardware in the processor or by using instructions in a form of software. The steps of the method disclosed with reference to at least one embodiment may be directly performed and completed by a hardware processor, or may be performed and completed by using a combination of a hardware module and a software module in the processor. The software module may be located in a mature storage medium in the art, for example, a random access register, a flash memory, a read-only memory, a programmable read-only memory, an electrically erasable programmable memory, or a register. The storage medium is located in the memory. The processor reads information in the memory, and completes the steps of the foregoing method together with the hardware of the processor. To avoid repetition, details are not described herein again.

The processor in at least one embodiment may be an integrated circuit chip, and has a signal processing capability. In at least one embodiment, the steps in the foregoing method embodiments may be completed through an integrated logic circuit of the hardware in the processor or by using instructions in a form of software. The processor may be a general-purpose processor, a digital signal processor (DSP), an application-specific integrated circuit (ASIC), a field programmable gate array (FPGA) or another programmable logic device, a discrete gate, a transistor logic device, or a discrete hardware component, and may implement or execute the methods, the steps, and logical block diagrams disclosed in at least one embodiment. The general-purpose processor may be a microprocessor, or the processor may be any conventional processor or the like.

At least one embodiment further provides a computer-readable medium. The computer-readable storage medium stores a computer program, and in response to the computer program being executed by a computer, the function of any one of the foregoing method embodiments is implemented.

At least one embodiment further provides a computer program product. In response to the computer program product being executed by a computer, the function of any one of the foregoing method embodiments is implemented.

All or some of the foregoing embodiments may be implemented by using software, hardware, firmware, or any combination thereof. In response to software being useable for implementation, all or some of embodiments may be implemented in a form of a computer program product. The computer program product includes one or more computer instructions. In response to the computer instructions being loaded and executed on a computer, all or some of the procedures or functions according to at least one embodiment are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (digital video disc, DVD)), a semiconductor medium (for example, a solid state disk (solid state disk, SSD)), or the like.

The “embodiment” mentioned throughout embodiments described herein means that particular features, structures, or characteristics related to the embodiment are included in at least one embodiment. Therefore, embodiments described herein do not necessarily refer to a same embodiment. In addition, these particular features, structures, or characteristics may be combined in one or more embodiments in any appropriate manner. In at least one embodiment, sequence numbers of the foregoing processes do not mean an execution sequence. The execution sequence of the processes should be determined based on functions and internal logic of the processes, and should not constitute any limitation on the implementation processes of at least one embodiment.

In at least one embodiment, “when” and “if” mean that UE or a base station performs corresponding processing in an objective situation, but do not constitute any limitation on time, and the UE or the base station is not used to perform a determining action during implementation, and do not mean other limitations either.

In addition, the terms “system” and “network” may be useable interchangeably in embodiments described herein. The term “and/or” in embodiments described herein refers to only an association relationship between associated objects and is useable to indicate that three relationships may exist. For example, A and/or B may indicate the following three cases: Only A exists, both A and B exist, and only B exists.

In at least one embodiment, “B corresponding to A” is useable to indicate that B is associated with A, and B may be determined based on A. However, determining B based on A does not mean that B is determined based only on A. B may alternatively be determined based on A and/or other information.

The foregoing descriptions are merely embodiments of the technical solutions, and are not intended to limit the protection scope of embodiments described herein. Any modification, equivalent replacement, improvement, or the like made within the principle of embodiments described herein should fall within the protection scope of at least one embodiment.

1. A communication method, comprising:
receiving a first signal from a network device, wherein the first signal is useable for time synchronization, and the first signal is useable to indicate at least one time unit in a first time period; and
sending first data to the network device in a first time unit, wherein the first time unit is one of the at least one time unit.

2. The method according to claim 1, wherein before the sending the first data to the network device in the first time unit, the communication method further comprises:
determining that the first time unit is not occupied.

3. The communication method according to claim 2, wherein the determining that the first time unit is not occupied includes:
determining, through channel monitoring, that the first time unit is not occupied.

4. The communication method according to claim 2, wherein the first signal includes fourth indication information, the fourth indication information is useable to indicate that the first time unit is not occupied, and the determining that the first time unit is not occupied includes:
determining, based on the fourth indication information, that the first time unit is not occupied.

5. The communication method according to claim 1, wherein the first signal includes first indication information, and the first indication information is useable to indicate that the first time unit is an uplink time unit.

6. The communication method according to claim 1, wherein the first signal includes second indication information, and the second indication information is useable to indicate a length of each of the at least one time unit.

7. The communication method according to claim 1, wherein the first signal includes third indication information, and the third indication information is useable to indicate a quantity of the at least one time unit.

8. The communication method according to claim 1, further comprises:
receiving a second signal from the network device, wherein the second signal is useable for time synchronization, the second signal is useable to indicate at least one time unit in a second time period, the at least one time unit in the second time period includes a second time unit useable for downlink transmission, and the second time unit has an association relationship with the first time unit; and
receiving second data in the second time unit.

9. The communication method according to claim 8, wherein the second data is feedback information of the first data, and the communication method further comprises:
when the feedback information is not received in the second time unit, or in response to the feedback information being useable to indicate that transmission of the first data fails, retransmitting the first data in a third time unit in a third time period, wherein the third time period is after the second time period, and the third time unit is useable for uplink transmission.

10. The communication method according to claim 9, further comprises:
receiving fifth indication information from the network device in the second time unit, wherein the fifth indication information is useable to indicate the third time unit.

11. A communication method, comprising:
sending a first signal to a terminal device, wherein the first signal is useable for time synchronization, and the first signal is useable to indicate at least one time unit in a first time period; and
receiving first data from the terminal device in a first time unit in the at least one time unit.

12. The communication method according to claim 11, wherein the first signal includes first indication information, and the first indication information is useable to indicate that the first time unit is an uplink time unit.

13. The communication method according to claim 11, wherein the first signal includes second indication information, and the second indication information is useable to indicate a length of each of the at least one time unit.

14. The communication method according to claim 11, wherein the first signal includes third indication information, and the third indication information is useable to indicate a quantity of the at least one time unit.

15. The communication method according to claim 11, wherein the first signal includes fourth indication information, and the fourth indication information is useable to indicate that the first time unit is not occupied.

16. The communication method according to claim 11, further comprises:
sending a second signal to the terminal device, wherein the second signal is useable for time synchronization, the second signal is useable to indicate at least one time unit in a second time period, the at least one time unit in the second time period includes a second time unit useable for downlink communication, and the second time unit has an association relationship with the first time unit; and
sending second data in the second time unit.

17. The communication method according to claim 16, wherein the second data is feedback information of the first data, and in response to the first data failing to be received, the communication method further comprises:
receiving the first data in a third time unit in a third time period, wherein the third time period is after the second time period, and the third time unit is useable for uplink transmission.

18. The communication method according to claim 17, further comprises:
sending fifth indication information to the terminal device in the second time unit, wherein the fifth indication information is useable to indicate the third time unit.

19. A communication apparatus, comprising:
a processor, configured to execute a computer program stored in a memory, to enable the processor to perform:
receiving a first signal from a network device, wherein the first signal is useable for time synchronization, and the first signal is useable to indicate at least one time unit in a first time period; and
sending first data to the network device in a first time unit, wherein the first time unit is one of the at least one time unit.
